(19) United States
(12) Patent Application Publication
(10) Pub. No.: US 2014/0030688 A1
(43) Pub. Date: Jan. 30, 2014

(54) SYSTEMS, METHODS AND PROGRAM PRODUCTS FOR COLLECTING AND DISPLAYING QUERY RESPONSES OVER A DATA NETWORK

(71) Applicant: ARMITAGE SHEFFIELD, LLC, Willowbrook, IL (US)

(72) Inventors: Christopher Lolli, Winnetka, IL (US); James Monte Henige, Hinsdale, IL (US); David Cushing, Rochester Hills, MI (US); Thomas Galbreath, Chicago, IL (US); Alan Helgeson, Chicago, IL (US); Michael Brucher, Bloomingdale, IL (US); Frank O'Connor, Barrington Hills, IL (US)

(73) Assignee: ARMITAGE SHEFFIELD, LLC, Willowbrook, IL (US)

(21) Appl. No.: 13/951,146

(22) Filed: Jul. 25, 2013

Related U.S. Application Data
(60) Provisional application No. 61/756,315, filed on Jan. 24, 2013.
(60) Provisional application No. 61/675,458, filed on Jul. 25, 2012.

(51) Int. Cl. G09B 7/00

(52) U.S. Cl. CPC G09B 7/00
USPC 434/350

(57) ABSTRACT

One method for communicating recommendations over a data network, comprising the steps of an initiating participant asking a question of a primary responder over the network; the primary responder providing a first answer to the question over the network and recommending at least one secondary responder to provide an answer to the question; each of the at least one secondary responder providing a second answer to the question over the network and further recommending at least one tertiary responder to provide an answer to the question; the at least one tertiary responder providing a third answer to the question over the network; and, a computer receiving each of the first, second and third answers and displaying them in a hierarchical manner.

### CROSS REFERENCE

The present application claims priority to two different U.S. provisional patent applications, namely Ser. No. 61/756,315 filed on Jan. 24, 2013, and Ser. No. 61/675,458 filed on Jul. 25, 2012 under 35 U.S.C. §119(e); both of which applications are incorporated herein by reference.

### TECHNICAL FIELD

A field of the invention is methods, systems and program products for communicating questions and collecting and displaying answers from a plurality of responders over a data network. Other fields of the invention include methods, systems and program products for communicating and displaying information over a data network. Still other fields will be apparent through consideration of the below.

### BACKGROUND

The internet and other network communications systems are revolutionizing communications between individuals. Individuals use the internet and other networks for social interaction, for seeking advice and information on topics of interest, for obtaining financial, legal and other professional information, and to answer specific questions, among many other purposes. Although the internet and other networks have opened up many new opportunities for such communications and queries, problems remain unresolved.

As an example, the extreme proliferation of the internet and other networks has led to what some refer to as “information overload.” When searching for an answer to a question, for instance, an internet user can be overwhelmed with the number of potential sources of answers on-line. The number can be so huge and lacking any sort of organization such that the available information loses relevance.

Further, other potential issues with the state of the art relate to a trust factor. The anonymity of the internet and other networks is advantageous for many purposes, but for some others creates disadvantages. As an example, a user seeking an answer to a question over the internet may have little information to judge the overall reliability or qualifications of a source providing an answer. This can lead to a lack of confidence or trust in the information that is disadvantageous.

### SUMMARY

A method for communicating information over a data network and for displaying resultant information over the data network, comprises the steps of: an initiating participant asking a question of a primary responder over the network; the primary responder providing a first answer to the question over the network and recommending at least one secondary responder to provide an answer to the question; each of the at least one secondary responder providing a second answer to the question over the network and further recommending at least one tertiary responder to provide an answer to the question; the at least one tertiary responder providing a third answer to the question over the network; and, a computer receiving each of the first, second and third answers and creating a graphical display that displays the answers in a hierarchical manner that graphically indicates the relationship between the primary responder, the at least one secondary responder, and the at least one tertiary responder.

Another invention embodiment is a computer program product for collecting, organizing and displaying answers to at least one question, the program product comprising executable instructions stored in a non-transitory memory, the instructions when executed causing one or more computers to carry out steps comprising: receive registration data from a plurality of responders over the network, each of the responders providing credentials, personal information and a password; store the registration data in a non-transitory memory; receive a question from a requester over the network and communicating the question to a first set of responders that has been specified by the requestor; receive answers to the question and a second set of responders from the first set of responders over the network; communicate the question to the second set of responders; receive answers to the question and a third set of responders from the second set of responders over the network; communicate the question to the third set of responders; receive answers to the question and a fourth set of responders from the third set of responders over the network; communicate the question to the fourth set of responders; receive answers to the question from the fourth set of responders over the network; create a graphical display that represents each of the answers received from the first, second, third and fourth sets of responders in a hierarchical arrangement that indicates relative distance from the requestor wherein the answers received from the fourth set of responders are displayed a greater distance from the question than are the answers received from each of the first, second and third set of responders; and, receive a request from at least one third party to view the graphical display together over the data network and respond to the request by displaying the graphical display, wherein the at least one third party is not a requestor or a responder.

Another invention embodiment is a computer program product for collecting, organizing and representing responses to at least one question in a graphical display, the program product comprising executable instructions stored in a non-transitory memory, the instructions when executed causing one or more computers to carry out steps comprising: receiving registration data from a plurality of responders over the network, each of the responders providing credentials, personal information, a password and demographic information; receiving a question from a requester over the network and communicating the question to a first set of three primary responders that has been specified by the requestor; receiving answers to the question and a second set of three secondary responders from each of the first set of responders over the network; communicating the question to the each of the secondary responders; receiving answers to the question and a set of three tertiary responders from each of the secondary set of responders over the network; communicating the question to the each of the tertiary responders; creating a graphical display of at least three concentric arcs of nodes around a center, each concentric arc including a plurality of nodes, a first of the arcs representing the primary responders with one node representing each primary responder, a second of the arcs representing the secondary responders with one node representing each secondary responder, the third of the arcs representing the tertiary responders with one node representing each tertiary responder, the graphical display further including connections between responders in different of the first, second, third and arcs; and, responding to selection of a node by a user by displaying the corresponding response, responder identity, and at least a portion of the corresponding credentials and demographic information.

Some other embodiments of the invention include systems, methods and program products for submitting questions over a data network to geometrically progressing selected responders and displaying resulting answers in a hierarchical manner that corresponds to the geometrical progression.

### BRIEF DESCRIPTION OF THE DRAWINGS

The attached and below FIGS. 1-29 are useful to illustrate an internet based example embodiment of a system, method and program product of the invention, and include sample screenshots together with explanatory comments.

FIG. 1 is a first screenshot of a home page according to an exemplary embodiment of the present disclosure;

FIGS. 2-3 illustrate screenshots of an exemplary web page used for receiving, entering credentials and inviting responders according to an exemplary embodiment of the present disclosure;

FIG. 4 is a second screenshot of the home page of FIG. 1;

FIG. 5 is a first screenshot of an exemplary search results page according to an exemplary embodiment of the present disclosure;

FIGS. 6-7 illustrate screenshots of an exemplary invitees page according to an exemplary embodiment of the present disclosure;

FIGS. 8-9 illustrate screenshots of an exemplary pyramid view page according to an exemplary embodiment of the present disclosure;

FIG. 10 is a third screenshot of the home page of FIG. 1;

FIGS. 11-13 illustrate screenshots of an exemplary public and private profile pages according to an exemplary embodiment of the present disclosure;

FIG. 14 is a second screenshot of the search results page of FIG. 5;

FIGS. 15-18 illustrate an exemplary use of the present system in a mobile device;

FIGS. 19-20 are flow charts of an exemplary process of the present system according to an exemplary embodiment of the present disclosure;

FIGS. 21-25 illustrate screenshots of an exemplary interface web page according to an exemplary embodiment of the present disclosure;

FIGS. 26-28 illustrate screenshots of a web page depicting an exemplary network structure between requesters and responders according to an exemplary embodiment of the present disclosure; and

FIG. 29 is a screenshot of the web page of FIG. 26 featuring a zoomed-in view of a portion of the present network structure.

### DETAILED DESCRIPTION

Before describing invention embodiments in detail, it will be appreciated that the present invention may be embodied in a method, a system or a program product including executable instructions stored in a non-transitory memory. Further, a method of the invention may be carried out by a system of the invention which may include one or more computers executing a program product of the invention. Accordingly, it will be appreciated that in considering a particular method, system or program product embodiment, description of other embodiments may be had. Illustration of a method embodiment, for example, may be useful to also illustrate a program product that carries out the method, and vice-versa.

Embodiments of the invention are practiced using computer, data, phone, and other communications networks, which may be wired or wireless, and which include but are not limited to the internet. One or more computers on such a network may be, be part of, or otherwise be used in practicing invention embodiments. “Computers” as used herein include processor based devices that include, but are not limited to, laptop computers, desktop computers, server computers, pad and tablet devices, client computers, mobile devices, portable phones, smart phones, portable entertainment devices, hand held or wearable processor based devices, and the like. Indeed, it will be appreciated that a multitude of devices carry out computing functions and may be considered computers for purposes of practice of invention embodiments.

### A. First Set of Example Embodiments

Turning now to example embodiments, some are referred to using the title “Rec3” for convenience, which refers to an embodiment in which “recommendations” are sought from sets of 3 responders. It will be understood that such reference is for convenience only, and that other embodiments will take different forms. In one example embodiment, Rec3 is a system of micro-recommendations (100 characters or less) whereby a client may provide a recommendation on a subject of interest and invite others to provide recommendations. It will be appreciated that the term “recommendation” is used for convenience and illustration. A recommendation may be, for example, an answer or other response to a question or request. It may be verbal, textual, numerical or other information.

By way of further illustration, the terms “question” and “answer” as used herein are intended to be broadly interpreted to include recommendations, opinions, and the like. As specific examples to further illustrate various invention embodiments, “questions” and “answers” in some invention embodiments may include “subjects” and “opinions.”

| Example Question: | Example Answer: |
|---|---|
| Best restaurant in Kansas City? | O'Malley's Steak |
| | House |
| Tips for getting a 3^{rd} grader to do | Turn math into game |
| homework | |
| What is the meaning of life? | Living for others, not |
| | yourself |
| What is your opinion on governor's | Like it |
| new bill? | |
| Capital of New Zealand? | Queensland |
| Favorite color? | Blue |
| Good honeymoon location and time? | Paris in the fall |
| What would Harry Potter do if he got | Magic trick |
| a traffic ticket? | |
| What store is best for 12 yr old girl | Justice or Abercrombie |
| fashions? | |
| Best recipe for ice cream sundae? | Vanilla ice cream and |
| | butterscotch syrup |

Those that provide answers/recommendations may then invite others to offer further recommendations on the same topic geometrically expanding the network of responders emanating from the originator as represented by a pyramid. Any series of micro-recommendations can be viewed by all or a subset of users in a number of different ways.

As used herein, the term “recommend” as used in the context of a step of recommending others to provide an answer is intended to be broadly interpreted. It may include, by way of example and not limitation, selecting, choosing, asking, and the like, from a defined or undefined group of individuals (who may provide further answers or recommendations). In some embodiments, a communication direct from a first responder (recer) is communicated to those they recommend (who will become second responders or recer's), and in other embodiments the first responder communicates the identity and/or location address of second responders to a central computer (which may be one or more servers) that then communicates the question or request to the secondary responders. In this manner, different invention embodiments include sending communications directly between responders or only through a central computer.

In some embodiments the growth of a network or responders and resulting recommendations is geometric but the use of invitations conforms the network into a definable structure. In the example embodiment Rec3 this structure is depicted as a “pyramid” which widens as levels are added below the top and can have limitless size given people's interest in providing input to the subject that the initiator started. Many other graphical presentations are useful in other example embodiments, including those that relate a hierarchical arrangement that visually illustrates a progression of requests and corresponding responses as they advance through new levels of users starting from a single requestor. An example of a hierarchical display, in addition to a pyramid, is a graph, chart, image or other display showing multiple sequential levels or groups and graphically indicating some logical connection between members of the different groups or levels. In considering the below example embodiment that includes a pyramid representation, it will be appreciated that this is but one example. Another example, for instance, is presented below including a semi-circular graphical display with different sequential levels represented as concentric semi-circle rings extending outward from the initiating center.

An example of geometric growth (Σ3ⁿ, n=1-10) of people that are part of a pyramid or other graphical presentation which grows to 10 levels below the initiator is given below:

| | |
|---|---|
| 3⁰ | 1 |
| 3¹ | 3 |
| 3² | 9 |
| 3³ | 27 |
| 3⁴ | 81 |
| 3⁵ | 243 |
| 3⁶ | 729 |
| 3⁷ | 2,187 |
| 3⁸ | 6,561 |
| 3⁹ | 19,683 |
| 3¹⁰ | 59,049 |
| Total | 88,573 |

Note that the numbers of content items created when combined—responders, recommendations and any related individual information—are a multiple (and in some embodiments an exponential) of the number of people in the table above by several orders of magnitude.

All Rec3 content can be searched and sorted along multiple dimensions including specific topics, responses, recommender attributes, credentials, metrics of pyramid creation, etc. Recommendation pyramids may be searched and viewed by all users but you can only make a recommendation in a pyramid to which you've been invited or have started. Recommenders will offer a character-limited description of themselves which will provide users with information related to their qualifications or credentials influencing how their response(s) are perceived.

“Cred statements” is a term used in some embodiments to refer to the “credentials” or qualifications a particular responder has on a particular subject or topic of a question. In some embodiments, a cred statement is provided with every answer, in other embodiments cred statements are provided with only some answers, and in some embodiments cred statements are not provided or are provided only occasionally on an as-desired basis. Also, in some embodiments, cred statements for a particular user may be stored and recalled in the future when appropriate (for example, when a similar subject occurs). Example cred statements may be “mother of 8 year old twins” (for a question of best way to get 8 year olds to eat broccoli) or “been to Munich 16 times” (for a question of best hotel in Munich).

Other information may also be provided with answers, with an example being responder age, geographic location, educational background, profession, sex, race, political affiliation, annual income, and the like. This “demographic data” can be searched or used in creating corresponding pyramids and for other reasons. As an example, a user could view a pyramid or other graphical representation of a plurality of answers, and then search it or otherwise reorganize it according to selected demographic data. A pyramid could be changed, for instance, to only show (or to highlight) answers from women who live in California between the ages of 14-18.

Some features and benefits of this and other example embodiments include that:
Person to person and personal—as recommendations are tied to people and their credentials
Invite driven—recommendations/answers are only received from those that are invited to do so
Reciprocal—Leverages the reciprocity principle—users appreciate being recommended and are more likely to respond after being recommended
Concise and fast—delivers information as limited text strings (limited to 100 characters or other limit)—cuts through the clutter of excessive information
User and content growth is geometric (each responder invites multiple other responders)
Content is created by users, continuously evolving and accruing
Information organized intuitively, in a person to person hierarchy as represented by a pyramid
Transparent—as people share the recommendations and thoughts with the intent of soliciting the same from others—honest and straightforward on privacy
Freeform and “subject” unbounded but character-limited maximizing flexibility in use while enabling faster search of content
Open to anyone with a point of view not just experts
Micro—as in recommendations on subsets upon subsets of topics
Highly searchable “private” content unreachable by public search engines
Mobile—as characteristics work well in a mobile environment
Psychological—as people take pride in being asked to share their opinion and will offer recommendations for profit, fun or pride in addition to soliciting information
Personal brand building—as your recommendation identity will be communicated by your public profile—how many times have you started or do you appear in pyramids
Useful as you can discover unique information
Vicarious—you can see what celebrities and experts think on subjects and whose opinion they solicit and how many degrees of separation people are from them.
Diverse users and uses—as the mineable information and commercial uses apply to multiple constituencies.
Connecting recommendations to known people creates a trusted search engine
Information returned by search can be overwhelming and Rec3 “headlines” or micro recommendations cut through the clutter to serve as a starting point to research or an end in themselves
Rec3 bridges gaps between who you know and what you know

### Example System/Method/Program Product Embodiment

Still another embodiment is described herein below, also using the term “Rec3” to describe the example embodiment. It will be appreciate that this term is not intended to limit the scope of the invention, but instead is simply a variable name assigned to one example embodiment for convenience. In other embodiments, other terms may be used. This example Rec3 system allows users to initiate topics, make recommendations, define their own credentials and invite others to recommend on that topic. An important component of the system is graphical displays with one example being “Pyramids,” although many other graphical presentations are useful in other embodiments (with an example being a semi-circular graph with concentric rings). The graphical presentations are info-graphical views or arrangements of the hierarchies of all recommenders. These may be presented in one, two, three or more dimensions. People making recommendations for a particular topic will become member of the pyramid for that topic. The system also incorporates a robust search feature where visitors and users are allowed to search for topics of their interest as well as search for recommenders by their names and get in-depth view of that recommender's participation in various pyramids across the system. Users are thereby allowed to view recommendations made by that recommender on each of the topic s/he participates in. The system also has an Admin user who will possess the ability to carry out all site management, user management, pyramids management activities as well as view different statistical reports.

One embodiment of Rec3 is a system of micro-recommendations (100 characters or less, although other limits may be used in other embodiments) whereby a client may provide a recommendation on a subject of interest and invite others to provide recommendations. Those that provide recommendations may then invite others to offer further recommendations on the same topic geometrically expanding the network of responders emanating from the originator as represented by a pyramid. People have lots of ideas, opinions and possess different degrees of knowledge about innumerable subjects. One purpose of this application is to enable users to generate free-form character-limited content by networking with people they know or should know, allowing them to share their knowledge with others, get views from others and establish and maintain their own “recommendation reputation” as a result of the process.

The micro-recommendations produced by users or clients of the system will be accessible by all visitors to the site and content will be linked to individuals who have stated why they know something about the topics for which they are providing recommendations. This combination of attributes will have the effect of making the web smaller by providing site visitors with concise statements about topics they are interested in, thus targeting their efforts to search for short-form answers to their questions. Content on the site is both “micro” and free form and not constrained by set categories.

As a result site visitors and users can quickly search for topics that matter to them. They may want to view what other people are saying about that issue or might be looking for a vehicle to share their knowledge/expertise on a subject. A site visitor may search and view all content on Rec3; however only by recommending and inviting others to recommend on a topic can someone join Rec3.

The core functions of the site allow users to state a topic of interest, make recommendations on the topic, write about their credibility in recommending on the topic, establish their public profile, and invite others to recommend on the topic. First-time users that do this may join Rec3. In addition, members and visitors will be able to search content and people on the site. Members will be able to maintain their public profiles and as the system is refined add information to a private profile. To engage users a great looking intuitive user interface is part of the system.

The hierarchies of topic initiators (i.e., 1st recommenders) and invitees that recommend on topics are robustly depicted via info graphical views called Pyramids in some embodiments, although other graphical arrangements may be provided in other embodiments. A Pyramid will exist for each new topic started on the site. The various parameters describing size, demographics of recommenders and speed of creation of Pyramids will lead to interesting conclusions about topics chosen by members of Rec3 as well as users of the system. For example a large pyramid implies a large number of people being invited and making recommendations on that topic. This may be an indication about the level of interest in the topic or the strength of the credibility of the invitees or both.

Other unique and important features of the system are the credential statements of the members. Each time the member makes recommendations on a particular topic, in some embodiments s/he has to specify his credential in a very concise manner. The credential statement defines the relevance of this topic to this member, and can also indicate the level of expertise and depth of experience of the recommender. Credential statements in some embodiments will prove an important factor in returning and ranking relevant search results when users are looking for recommenders and/or content. “Credentials” as used herein is intended to broadly refer to data describing qualifications of a responder as it relates to a particular request or subject or recommendation.

Search is another robust feature of the system. A basic key word search capability is implemented to search content including topics, recommendations, and credential statements. The system also incorporates Semantic Search in concert with customized algorithmic functions for returning content via the search function. Semantic search improves search accuracy by understanding searcher intent and the contextual meaning of terms as they appear in the searchable data space, whether on the Web or within a closed system, to generate more relevant results.

### User Types

The system in some embodiments defines at least 3 different types of users:

### Site Visitor

A Site Visitor is any non-registered user who can search and view all content including topics, micro-recommendations, credential statements and public profiles of the Site Members. Any Site Visitor may become a Site Member by recommending on a topic of their creation and inviting others, or by responding to an invitation from a Site Member to recommend on a topic.

### Site Member

There are two ways to join Rec3:

A) Being a 1st Recommender
1. New User comes to the site
2. Creates topic, makes recommendations, writes credential statement
3. Invites friends to recommend (invitee)
4. Enters name, email address, zip code and/or city, country and uploads photo
4. After Recommendation is submitted, system asks user for a password & email verification to facilitate his/her next visit

B) Responding to an Invitation from a Site Member to Recommend
1. Follow link in email invitation to the site and clicks into a process like Steps 2-5 above, excluding the creation of the topic

### Site Administrator

Site Admin has complete control over the site, wherein s/he can view all the happenings on the site, view statistics, reports & manage users. There can be one or more site admins defined in the system, as per requirement.
The system has a secure login process for users. There is also be a ‘Remember password’ feature along with forgot password feature wherein users receive a ‘reset your password’ link in their emails and they will be redirected to the ‘reset your password’ page on the site.

### Example System/Program Product Frontend Features

### User Dashboard

In a first embodiment of Rec3 the User Dashboard will be the Site Member's public profile. A Site Members public profile will include: First Name, Last Name, Email Address, Zip Code/City, Country (default United States) and an optional picture or logo. The User Dashboard is built so that features can be added as the system is refined.
Many features are added in other embodiments to enable the User Dashboard to serve as the page where the Site Member can see various alerts and feeds to give him/her a complete overview of his/her presence on the site. In these embodiments, settings may be available to allow Site Members to make certain parts of their profiles public and others private. Therefore ultimately there will be two profile views for each Site Member: Public & Private.
The different components of the user dashboard include:

### Alerts

Members can choose to receive alerts, which may be electronic communications, when:
1. Certain people recommend—Each user's public profile will have ‘Alert me when this person recommends’ link, which the member has to click and subscribe to this user's recommendation activities
2. These subjects have recommendations—Similarly, all subjects will have an ‘Alert me when this subject has recommendations’ link. A member signs up for alerts on an existing pyramid, including one which s/he may be part of. A member can set an alert for future subjects.
In some embodiments this is visualized similar to RSS feeds.
Members will also have alerts when their friends have invited them to make recommendations and they are yet to respond. This feature is a part of the member's private profile.

### Make Recommendation Verbiage and Icon

Member can initiate a topic and start with giving 3 recommendations as well as inviting 3 friends to recommend.

### Links

Members can link into third party applications, including social networking sites with examples including LinkedIn, Facebook and Twitter accounts on the site. These links become a part of his public profile.

### Topics Listing

Member can see topics that s/he might have initiated or made recommendations for, listed on his dashboard.

### User Pyramids

Members can view a list of his/her topics & the pyramids related to that topic.

### User Statistics

Statistics for a member may include:
1. No. of times s/he has been the 1st recommender
2. No. of times s/he has been invited to recommend
3. No. of recommendations s/he has made
4. No. of pyramids s/he appears in
5. His level in each of the pyramids s/he appears in or a summary view of how often s/he has been at various levels
6. Average level & Metrics calculations like no. of times user has appeared in expert or celebrity pyramids

### Import Contacts

1. Members can import contacts from Gmail, Exchange, Yahoo mail ids, Facebook, etc. S/he will enter the credentials of his mail id and system will fetch his contacts via APIs. Member can choose which contacts s/he wants to import into the system by selected checkboxes. These contacts will then be saved under the user's profile for future use.
2. Members can also manually enter friend email ids to be saved in the contacts book.

### Recommend Rec3 to Friends

Members can send emails to friends to visit and join Rec3 by registering.

### Recommendations

Users of the site can start a topic or respond to an invitation with 3 recommendations and invite 3 other friends. As a 1st Recommender it is mandatory to enter 3 recommendations himself and also invite 3 friends to recommend. As an invitee, or anyone invited to recommend on a topic by a Site Member, it is required to provide 3 recommendations and invite 3 others assuming that the person chooses to respond to the invitation.

### Make Recommendations & Invite Others

User follows the below steps:
1. User will enter Subject (100 characters or less)
2. User enters 3 of his own recommendations (mandatory fields) (micro-recommendations contain100 characters or less)
3. User defines his own credentials in a concise manner (100 characters or less in some embodiments), which actually defines why s/he is able to provide relevant viewpoints related to the topic
4. New users will invite friends by either importing their contacts or manually entering their mail ids. Members will choose their contacts from contacts imported in their contacts book
5. New users enter their profile information like First Name, Last Name, Email, Country, Zip, Town & Profile picture. Except profile picture, all other fields would be mandatory.
Members will see these fields pre-populated upon their subsequent visit to the Site. Some embodiments may include validations for junk or repetitive text entered by users in the recommendation textboxes. Spell check may be performed on all text fields for adding recommendations, with suggested corrected spellings indicated.

### Reminders

The system automatically communicates at specified intervals 1) reminders to invitees who have not yet responded, 2) notices to invitees that have not responded when one of the other invitees has responded and recommended on the subject.
Members can also individually communicate reminders to the invited users through the ‘Send Reminders’ feature

### Hierarchical Graphical Representation/Pyramids/Other

Invention embodiments include graphical displays of hierarchical arrangements of answers with credential and identifier information on the corresponding responders. The hierarchical arrangement indicates the relation between the original question, initiating requestor and each geometrically removed level of responders such that the sequence of answers along the geometrically expanding chain of responders is represented graphically. This can be done in a number of different manners, with examples including a graphical tree structure, a network node diagram, other two or three dimensional graphs and charts, a semi-circular graph with concentric semi-circular rings (as illustrated below), and the like.
One particular example is a pyramid (in one or two dimensions) or triangle pictorial/graphical view of the hierarchy of the initiator and the subsequent invitees/responders who become recommenders. The Pyramid will have a top to bottom view, where the initiator will sit at the top of the pyramid. All the people who have been invited and have responded to the invitation to make recommendation on this topic will be a part of this pyramid. The pyramid will be separated by levels, where the initiator of the topic stands at level 1, and his invitees at level 2 and so on. An initial view of the pyramid will not display all the levels at one go, since the pyramid can span up to multiple levels and pyramid views will be scrollable by the viewer.
In some example embodiments, the pyramid elements or cells would contain profile pictures or selected graphical images (icons, drawings, etc.) of the members of that pyramid (again, pyramid as used herein is intended to be one example of a graphical representation of a set of responders).
In some embodiments, the user will be able to “mouse over” or otherwise select recommenders' pictures and see their credential statement and three recommendations. Users will also be able to zoom in/out on specific recommenders and their invitees as they peruse the pyramid.
Users can select any person from the pyramid which will in turn take him to that person's recommendation page which shows his answers and list of his invitees. In some embodiments, the pyramid would have gaps when people do not respond. The pyramid would die a natural death when people invited do not respond since the pyramid would fail to grow to further levels. The system will set certain parameters to setup life time of a pyramid.
Pyramids can be viewed by anyone, not just those that started them or appear as invitees. A user does not have to be a registered user to view most pyramids and their content. A person, however, cannot insert themselves into someone else's pyramid but must start their own should they want to offer an opinion on a subject in a Pyramid into which they have not been invited. They also have to be a registered user in order to “rec”.
Some embodiments limit uses to inviting the number of responders or “recers”, with examples being no more than 2, no more than 3, no more than 4, no more than 5, and the like. The nature of limiting users to inviting some specific number, with an example being 3, other people to recommend or “rec” leverages strong social dynamics of exclusivity, feeling pleased to be in the “in” crowd that is asked their opinion, etc. but it does limit the network effect. To increase the network effect of Rec3 while preserving the benefits of a limited invite list a “rec the R3 cloud” feature allows a “recer” (a recommender or responder or other user) to also elect to “rec the R3 cloud” anonymously. The term “R3 cloud” is intended to be broadly interpreted as a universe of users that have preregistered or otherwise been pre-defined or selected to be accessed when one “rec's the R3 cloud.” In one embodiment, the R3 cloud consists of registered users who have volunteered to offer their opinion on a variety of subjects should they be “reced” on and a “recer” or invitee selects “rec the R3 cloud”. Different “clouds” may be defined using different demographics, subjects, and the like. As an example, one “cloud” may be defined as only female users between the ages of 23-33 that live in a particular geographic region, while a second cloud may include male and female users that have purchased a particular brand of product previously. Within invention embodiments, “clouds” can be defined using any variety or combination of demographic, consumer, or other information. It is expected that many people will utilize this option both to augment the recommendations they receive and to build their reputation as a recommender or “recer”.
Some embodiments also provide logical cross linking between different pyramids. Graphical links connecting the same (or related) responders/recers, common or related questions, or the like may be provided. In such circumstances, selecting a “show related” or similar icon may cause the system to display the related pyramid(s).

### Pyramid Statistics

System embodiments will maintain certain Statistics on each of the pyramids inclusive of but not limited to:
1. No. of Recommenders in the pyramid
2. No. of Recommendations in the pyramid
3. No. of levels of the pyramid
4. No. of times the pyramid has been accessed by Search

### Speed of Pyramid Creation/Interrelation

Some embodiments create graphical links across multiple pyramids to indicate common or related recommenders, along with related questions or answers. Some embodiments use this and related features to show users the “network effect” of recommenders interacting with the system to pose topics, write recommendations and invite others to do the same

### Search

One embodiment of the system enables the user to perform key word search when clicking “Get Recommendation.” There are two types of Search in this system:
1. Get Recommendation (topic keyword search)
2. Find Recommender (Recommender name search)
   1. Get Recommendation
   User types in keyword search in the textbox, the system will return the nearest matches based on several factors defined in the algorithm. This algorithm brings the richest pyramids to the first results screen the user sees. The complete algorithm to search and then sort the results is:
      1. Key word match
      This search is performed across the content—questions, answers and credentials. Occurrences of keyword are measured and some level of semantic association is also identified (semantic search also included in some other embodiments).
      2. Total number of recommendations in pyramid
      This metric is a proxy for breadth and depth of content contained in a pyramid
      3. Total number of invitations received by recommenders in a pyramid
      This metric is possibly a proxy for the quality of the recommendations, as the more often the people in the pyramid have been invited to offer their opinions (in aggregate) the more likely their opinions may be valued by others.
      More recommendations mean a pyramid with more recommenders and levels giving the user a higher probability that they will find recommendations that appeal to them. The total number of invitations in a pyramid is an indicator of the collective credibility of the recommenders in the pyramid, again increasing the probability that the recommendations users find will appeal to them because the recommenders in the pyramid are asked to recommend often.
      4. Filter on zip, celebrity and expert
2. Find Recommender
Users enter recommender name in the textbox, system will return data similar to the ‘Get Recommendation’ search results, only that the resulting data will be displayed based on the nearest matching recommender names.
The system returns:
   1. The closest name matches and
   2. The public profile of the person selected
If the user selects a recommender from the returned search results, they would get a list of pyramids for that recommender. The user is then able to browse and view content and invitees in all of the pyramids that the recommender is in.
The system will eventually support semantic search and customized algorithms for searching free form content on the site. The semantic search feature will is more integral in other versions of the system.

### Other Features

Apart from the above mentioned front end features, some embodiments of the site further feature:
   FAQs—Site users can visit FAQ section for help
   Contact Us—Members can contact the site admin by filling up the ‘contact us’ form in case of any query, suggestion, complaint and so on
   Report abusive content—Users can report abusive content to the admin via the ‘report abuse’ link available beside each question/topic. Report abuse feature will be available to all users of the site, including visitors

Administration Features
The admin user will be a pre-defined user of the system. There may be multiple admin users as per requirements. The admin has a valid login authentication process as well as secure login.

### User Management

Admin can view all the registered users (members) of the system, view their activities on the site, view their pyramids or remove their membership with the site when necessary. Admin also has Search feature similar to the front end interface. Overall, the admin can see a complete profile of the member along with their contact details.

### Celebrity/Expert Management

Celebrity members will be certified by an off-board operation. Experts will also be an off-board operation for some embodiments. All these members are entered or updated into the system via the admin interface.

### Pyramids Management

The admin can adjust select parameters related to life cycle management of pyramids.
By default, a pyramid may be stopped, when the number of levels reaches a default number set by the system. However, admin may choose to stop the growth of any pyramid at any time if such action is warranted and withdraw a pyramid if necessary.
Features to archive or purge the content/pyramids based on admin managed settings are included in some embodiments.

### Customer Service

The Admin can manage the FAQ section visible to the customer at the front end interface. The admin will also be able to view all the requests, suggestions or queries posted by members and can respond to their email contacts. Site users have the ability to report abusive content; the admin will be able to see a section for abusive content thus reported. S/he will have an interface to remove the content from the site or take action against that particular member.

### Static Pages

Types of Static Pages:
About us (details about site statistics, top 5 topics, recommenders and so on)
Terms & Conditions
Privacy Page
Acceptable Use Policy
Tutorials & Videos for Site beginners

### Reports

Visitor logs Reports which include details as follows:
1. System—usage metrics, acceptable use monitoring.
2. Number of unique visitors by day, by week by month
3. Number of total visits by day, by week by month,
Reports mentioned in point 1 are provided by the hosting provider that the system is hosted on. Reports mentioned in points 2 and 3 can be managed by a third party function such as Google Analytics. Since the information about visitors, particularly non-registered users is captured only by Google Analytics, points regarding segregation of the information regarding registered and non-registered users, for points 2 and 3 above.
   Various reports are available to the admin for analysis purposes. Reports in the following list include but are not limited to:
1. Users—Number of registered users—total, new by day, new by week, new by month.
2. Number of first recommenders, total.
3. Number of new first recommenders by day, by week by month.
4. Members Statistics are reports similar to the section ‘User Statistics’ in the ‘User Dashboard’ section above.
5. Pyramid Reports are reports similar to the section ‘Pyramid Statistics’ mentioned in the ‘Recommendations’ section above.

### Address Book

One embodiment of Rec3 defines the address book of contacts from which the initial site users could invite people to recommend on topics. This function is controlled by the Site Admin. The Site Admin can turn off or otherwise enable the system to accept upload or entry of any contact(s) chosen by the user. The admin can import contacts file into the system, which will thereafter be available to the site users. Admin will not be able to edit any contact, but will be allowed to delete a contact. The site users can see all these contacts in their address books and invite them to make recommendations without having to import their own contacts or typing email address of their friends manually.

### Mobile Optimized Site Interface

Some versions of the web application are compatible with mobile devices including but not limited to iPhone, Android (devices like HTC One series, Samsung Galaxy Series, Sony Xperia Series) iPad, other tablets, phones, gaming systems, and others.

### Technology

Some invention embodiments utilize Open source technology including the following:
PHP
MySQL
LAMP

Other embodiments will use other code forms.

### Additional Example Rec3 System/Method/Program Product Embodiment Summary

Having now discussed embodiments of the invention in general and some level of detail, still further aspects of some invention embodiments are described in the following discussion, including an example internet based system, method and program product embodiment. These embodiments can be further appreciated by considering the attached Figures that are useful to specifically illustrate various features.

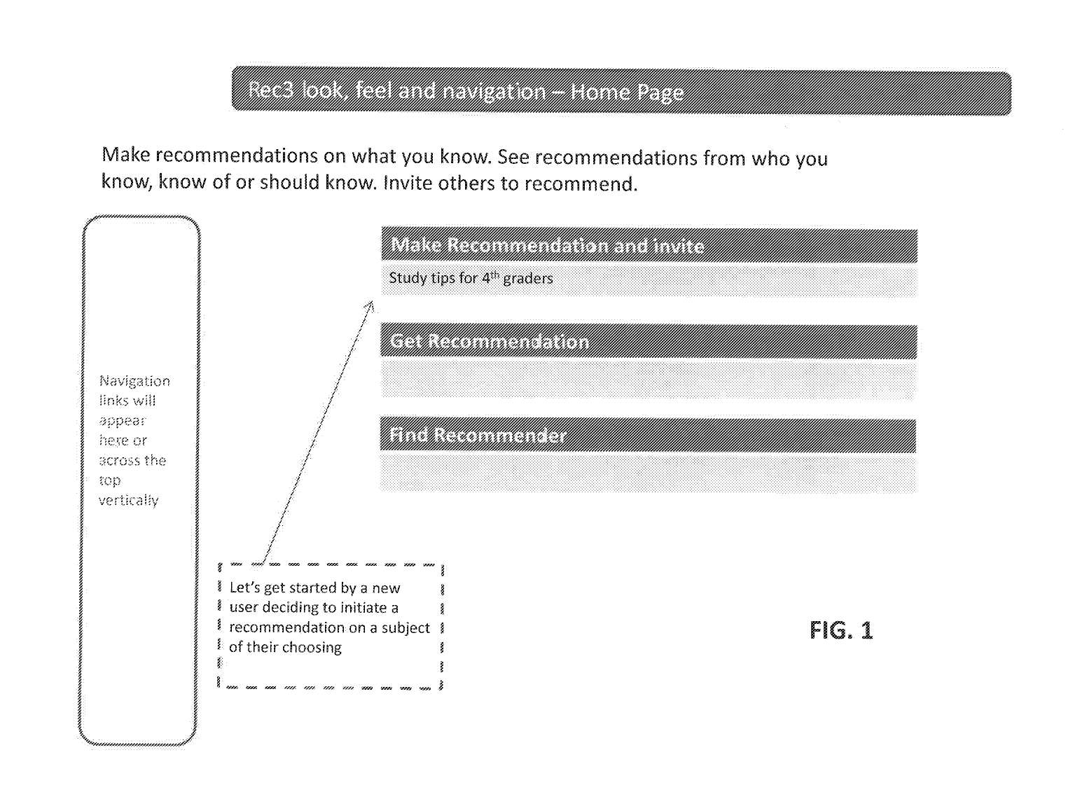

FIG. 1: Home Page
1. An example Rec3 Home Page has three input field boxes to initiate a subject or search content in the system, and design of UI should drive users to intuitively know to enter something there. Micro-format means all entries are 100 characters or less, although other limits may be used in other embodiments. The top input box is the start of two-screen engagement of the system to recommend, register (if first-time user) and invite others to recommend.
2. Pyramid graphic—selecting this or similar icon allows to start a pyramid or expressed more specifically make a rec and invite
3. An example embodiment Home Screen has a Trending Now on Rec3 window containing subjects most recently rec'd (subject statements)—the most popular questions being posed, based on either the number of times the question is asked or the number of responses received (i.e., the size of the resulting pyramid). This can be useful to spur activity. This is continually monitored for updating.
4. The system is username and password-protected for recers (members or users or responders) but not casual users. All subjects, rec's and cred statements on Rec3 can be accessed by anyone.
5. Navigation bar: “About,” “Terms of Service,” “Privacy” and “Contact.”

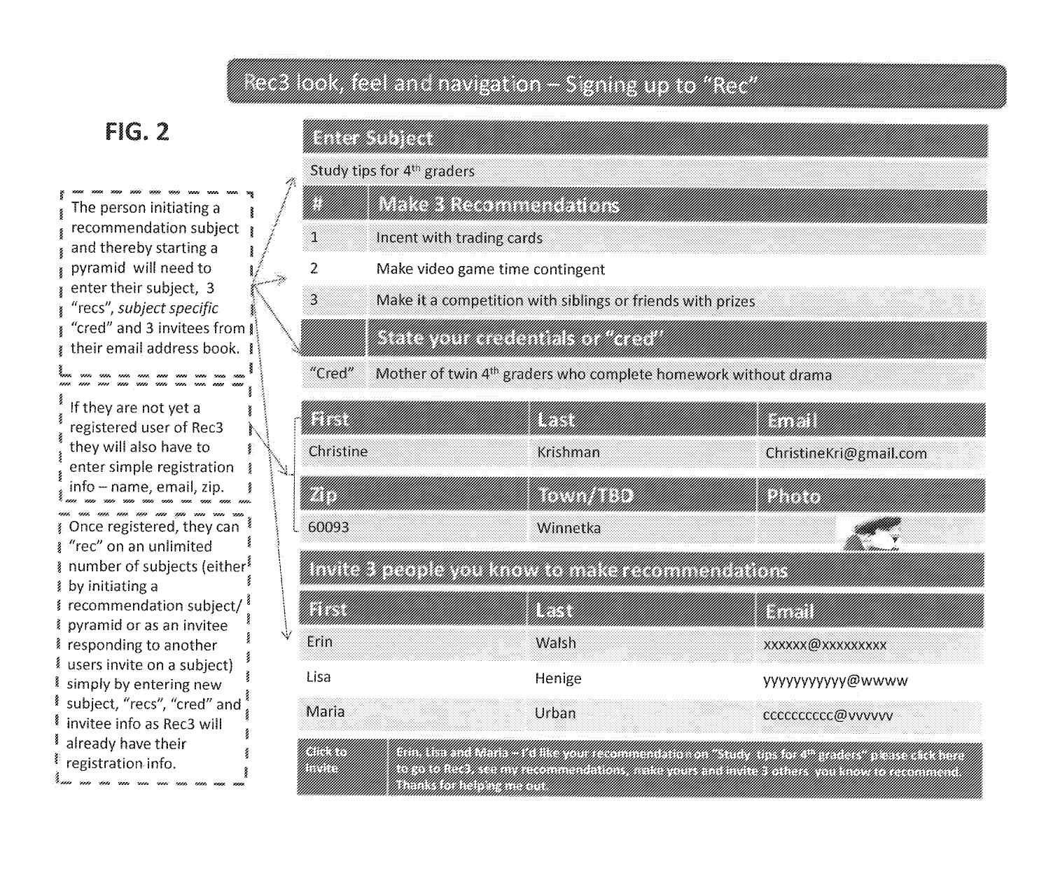

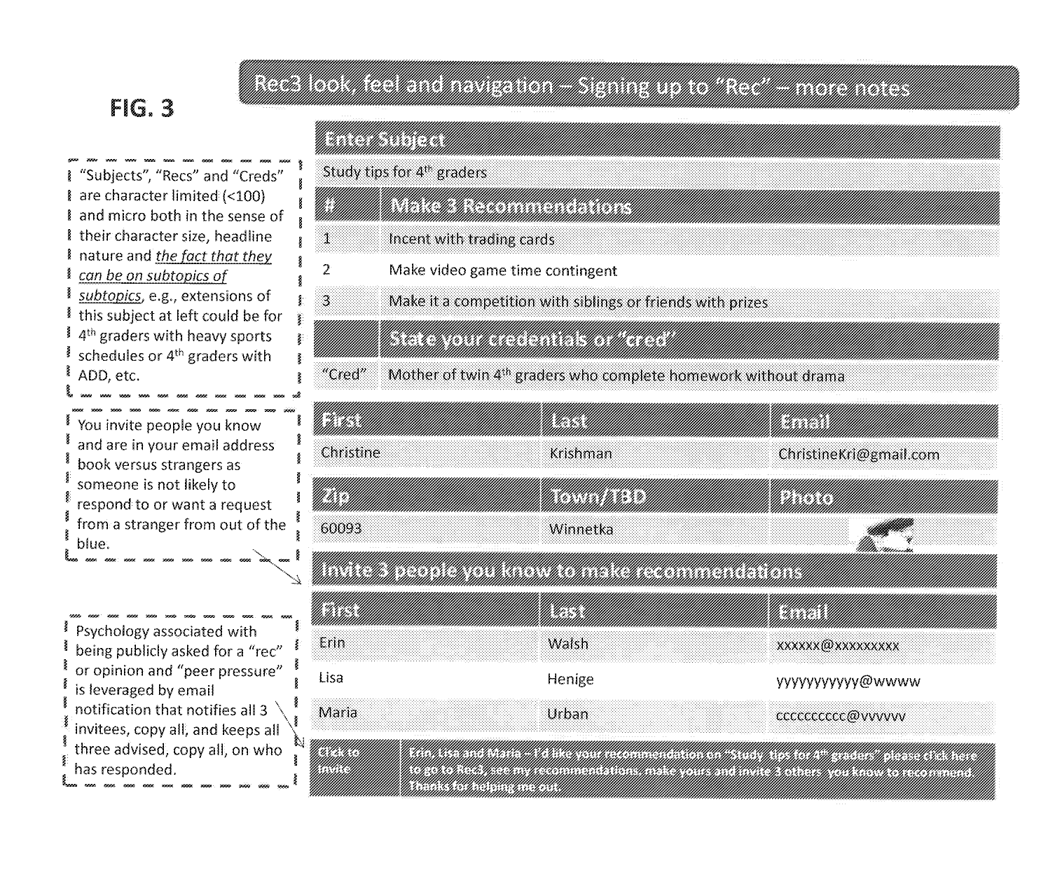

FIGS. 2-3: Receiving, Entering Credentials and Inviting Responders
1. Screens, especially where data is entered, exhibit all required entry fields on the same screen so user knows when they will be done.
2. The person initiating a recommendation subject and thereby starting a pyramid will enter their subject, 3 recommendations (“recs”), subject specific credentials (“cred”) and 3 invitees (responders) from their email address book.
3. If they are not yet a registered user of Rec3 they will also have to enter simple registration info—name, email, zip.
4. Once registered, they can “rec” on an unlimited number of subjects (either by initiating a recommendation subject/pyramid or as an invitee responding to other users invites on a subject) simply by entering new subject, “recs”, “cred” and invitee info as Rec3 will already have their registration info.
5. When reaching the step to invite others to rec, the system must be able to interface with the user's address book for electronic communications (email, text, other). We cannot force users to re-type email addresses for people they already have on file. Pre-formatted language may be used in the email.
6. The system confirms that the email was successfully sent.
7. “Subjects”, “Recs” and “Creds” are character limited (100 or less). Although 100 characters have been selected for use as a limit in some embodiments, other limits will be useful in others, including 50, 75, 144, 150, 200, and others.
8. Some embodiments of the invention query returning users for additional data about themselves for their profiles. These embodiments engage the user each time they log in, a question at a time with no requirement to answer.

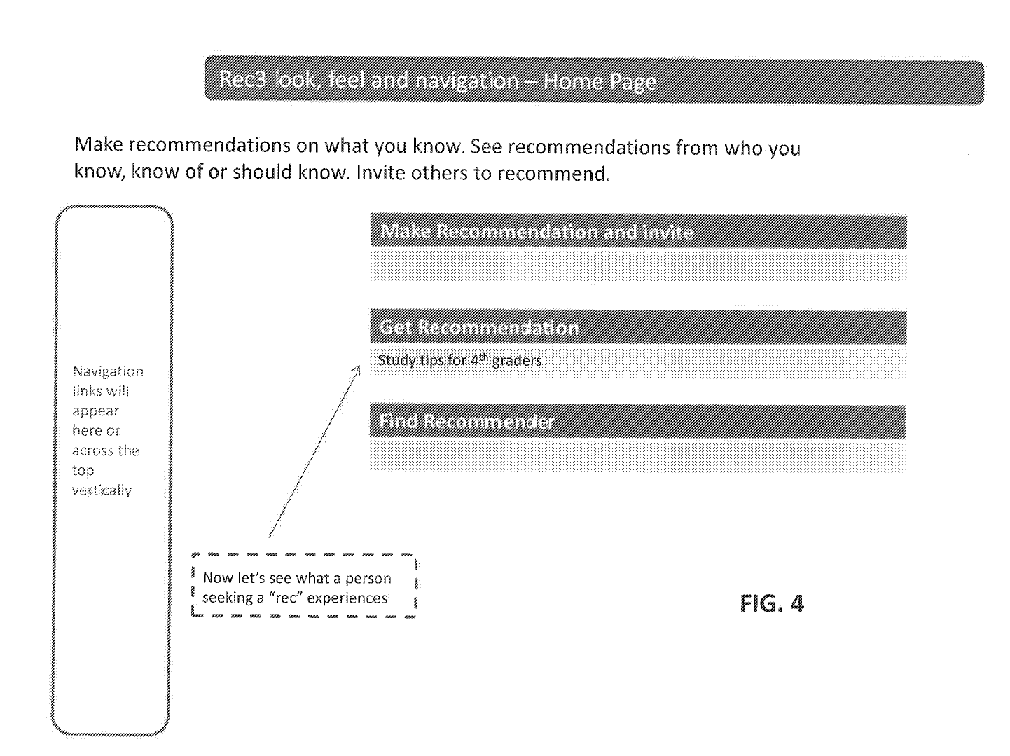

FIG. 4: Home Page—Get Recommendations (Subject Search)
1. The system produces quick returns; in general look is simple and clean, entry fields intuitive, return of information is quick and results are always returned upon search.

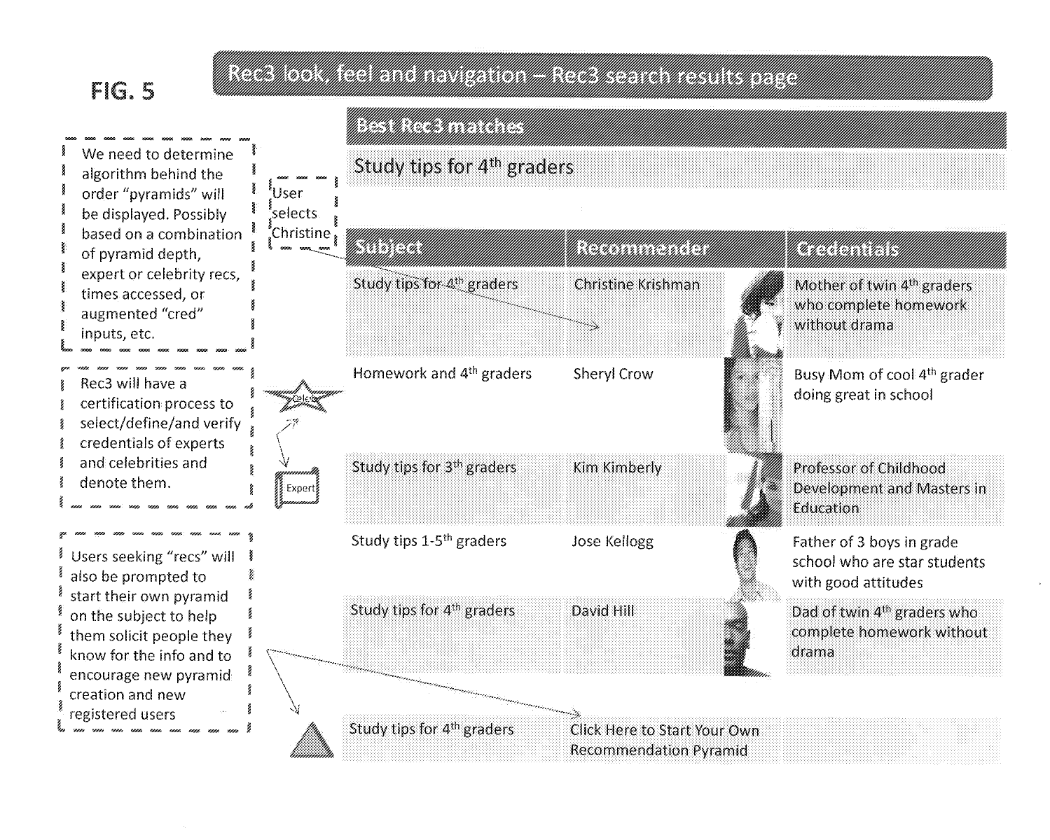

FIG. 5: Search Results
1. A Rec3 embodiment has a certification process to select/define/and verify credentials of experts and celebrities and denote them.
2. In one embodiment, the algorithm behind the order “pyramids” is displayed as proposed to be based on: a. Subject line key word match, then by b. # of total recommendations in the pyramid, and then by c. Total # of invitations received by the people in the pyramid.
3. Other embodiments allow users to filter results by zip code or other geographic location information and eventually cred statement strength or match to the subject. It has been discovered that people sometimes assign trust or reliability based on geographic location (e.g., people that live close by, people that live in a “smart” town/state/zip code, etc.)
4. Note pyramid ▴ icon at bottom left side. Again, a user has the option to start their own pyramid by rec'ing and inviting three others if they feel they have additional or better rec's to offer on the topic. Clicking the [symbol] brings the user to the 1-screen process on FIG. 1. This symbol appears on every search results page. Other graphical symbols may also be used.

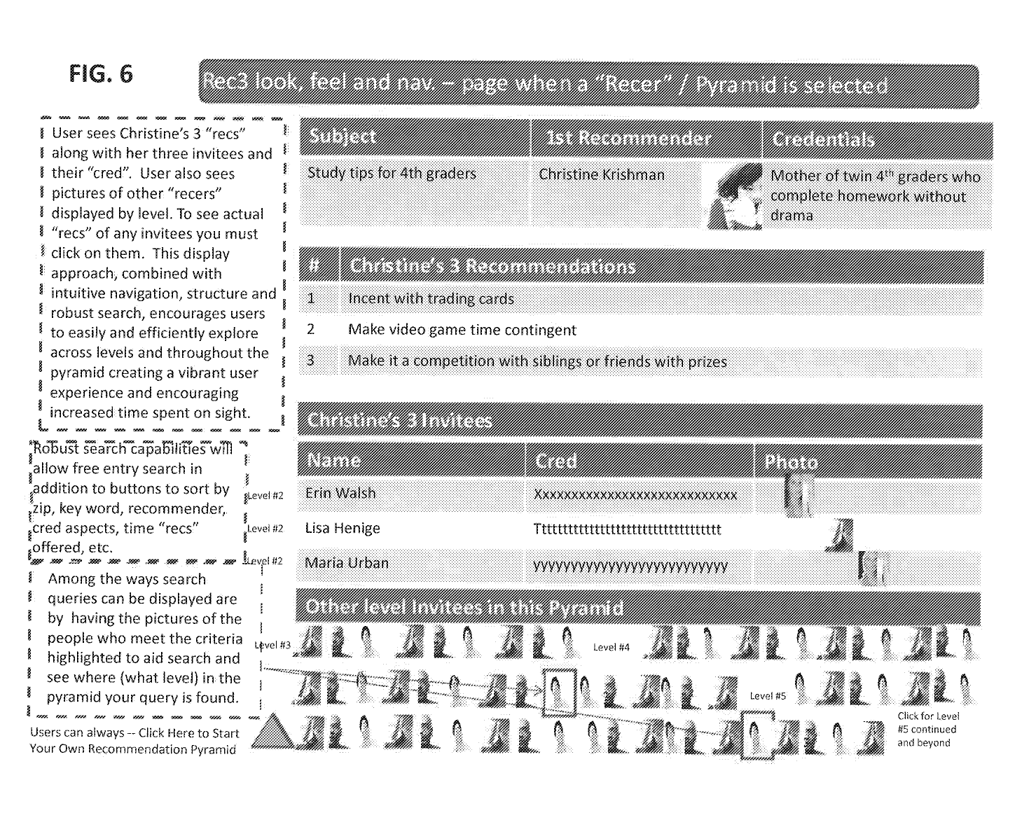

FIG. 6: See Recers Rec's and Invitees
1. To see actual “recs” of any invitees you must click or otherwise select them. This display approach, combined with intuitive navigation, structure and robust search, encourages users to easily and efficiently explore across levels and throughout the pyramid creating a vibrant user experience and encouraging increased time spent on the site.
2. In one embodiment, buttons are provided to sort by zip, most key word matches between subject requested and rec, alphabetical by recommender, celebrity/expert.
3. The red icon on this screen are an initial proposal for displaying the results of your filtering choice—pictures of the people who meet the criteria highlighted to aid search and see where (what level) in the pyramid your filter choice is matched.
4. Note pyramid icon is an option on this screen as well.

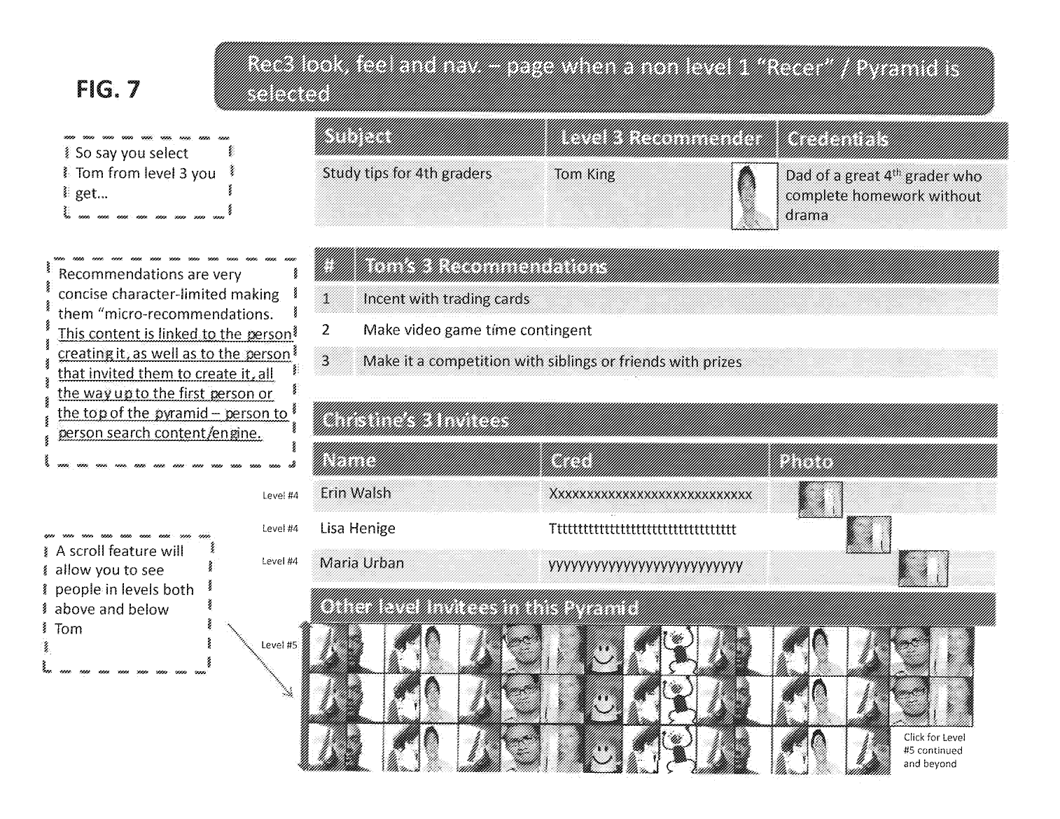

FIG. 7: See Rec's and Invitees from Other Levels—
1. Recommendations are very concise character-limited making them “micro-recommendations.” This content is linked to the person creating it, as well as to the person that invited them to create it, all the way up to the first person or the top of the pyramid—person to person search content/engine.
2. A scroll feature allows to see people in levels both above and below Tom (slider pictured in lower right-hand corner of screen).
3. Note pyramid icon is an option on this screen.

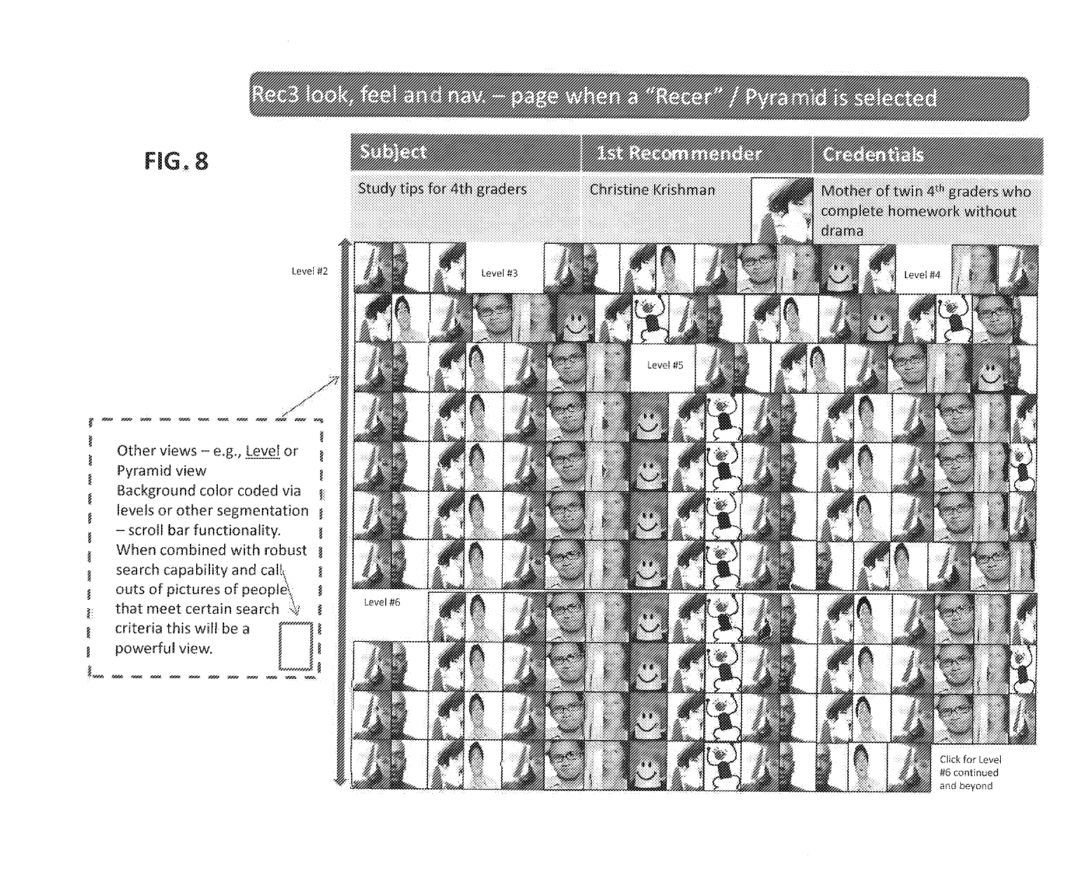

FIG. 8: “Level” View of all Recers Under the 1^{st} Recer of the Subject Match Chosen
1. Note scroll bar right-hand side allowing for selection of level, individual or the like
2. Feature idea—color-code the backgrounds for each level to indicate different levels
3. Red icon outlines people matching filter (if chosen)
4. Note pyramid icon is an option on this screen.

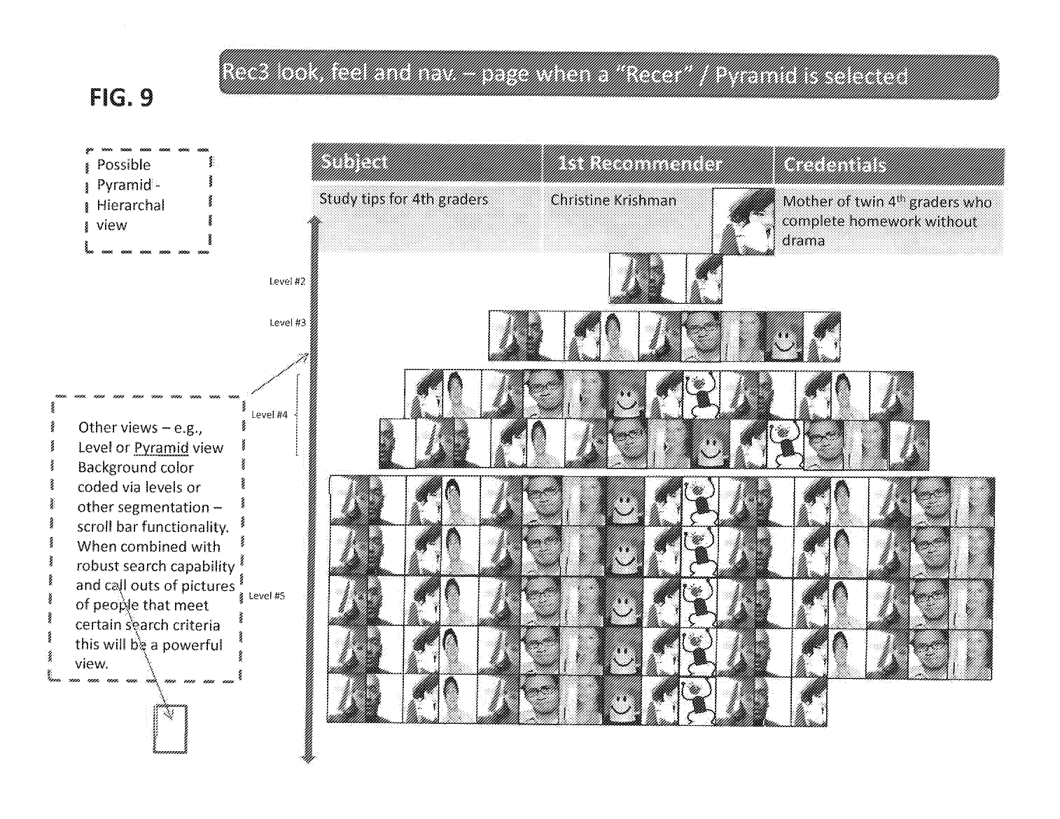

FIG. 9: “Pyramid” or Hierarchal View of all Recers Under the 1^{st} Recer of the Chosen Subject
1. Note scroll bar right-hand side allowing for selection of individual and/or level
2. Feature idea—color-code the backgrounds for each level
3. Red icon outlines people matching filter (in this case “zip code” was clicked)
4. Note pyramid icon is an option on this screen.

### Another Pyramid View—Manipulative Object

1. Embodiments allow for people to turn, flip, dig into, blow up (expand) and otherwise graphically interact with and manipulate displays to explore its contents. This can offer important commercial benefits for pad users in particular (or iPhone other android smartphones). Other manipulative features in some embodiments include a “web” of connectors between recers and their invitees where “quads” (i.e., recers and their invitees) can be zoomed in on and expanded. Some pyramids will be large and some small, depending upon number of recers on the specific topic.
2. Embodiments allow a user to select (e.g., click) to draw lists of celebs and experts out of the pyramid, lists should open in a new window within this screen to enable user to scroll and select.

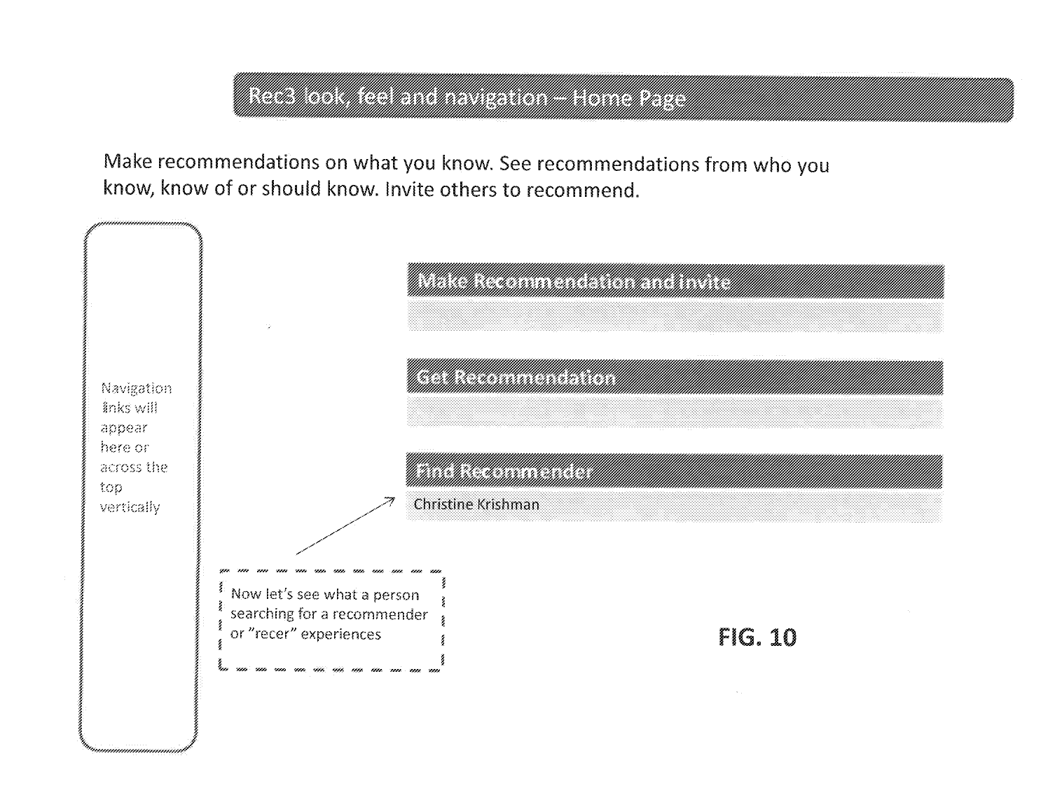

FIG. 10: Responder/Recommender/People Search
1. A system embodiment allows for searching by names of responders.
2. As a recommender name is typed into a field on the home page, the embodiment populates a list with possible people that match the provided name, and in some embodiments further info on the particular person is also provided. User can scroll up and down this list.

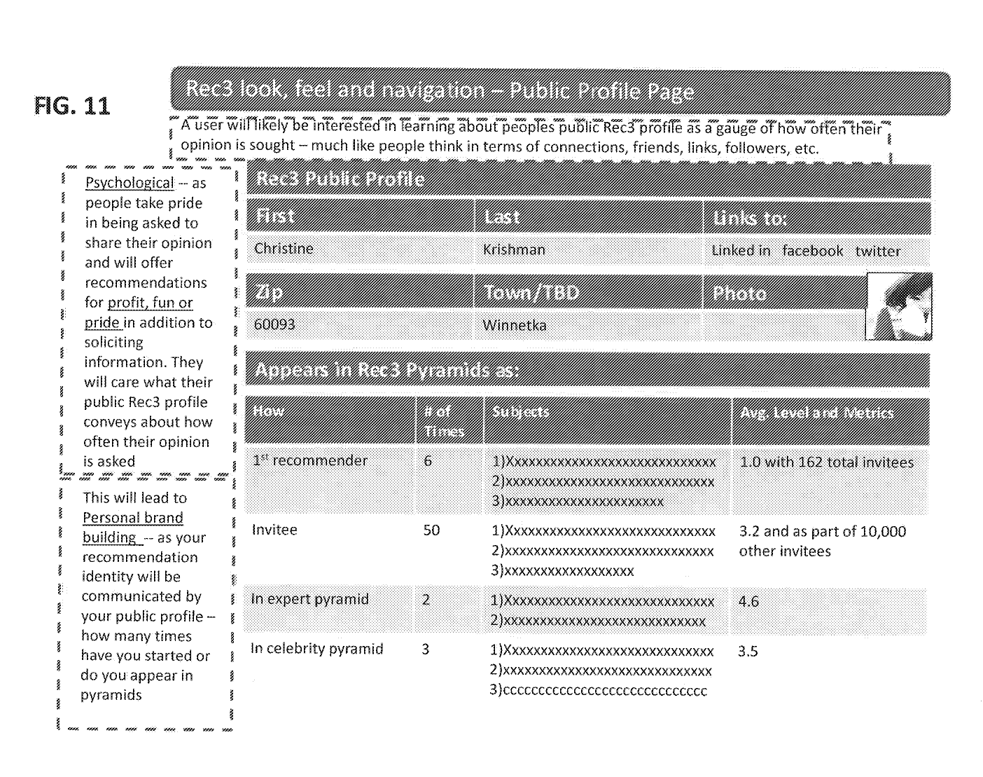

FIG. 11: Public Profile Screen
1. A summary of public attributes/data for a particular person/recer/responder
2. The numbers listed in column 2 are all hot links. When clicked, a list like FIG. 8 or 9, e.g., a list of pyramids, but for that person only is returned.
3. In some embodiments, the system will alert users when a designated responder recommends. This would require another “private profile” view accessible only by the registered user. Communications via a text or email to that person from this screen are possible.

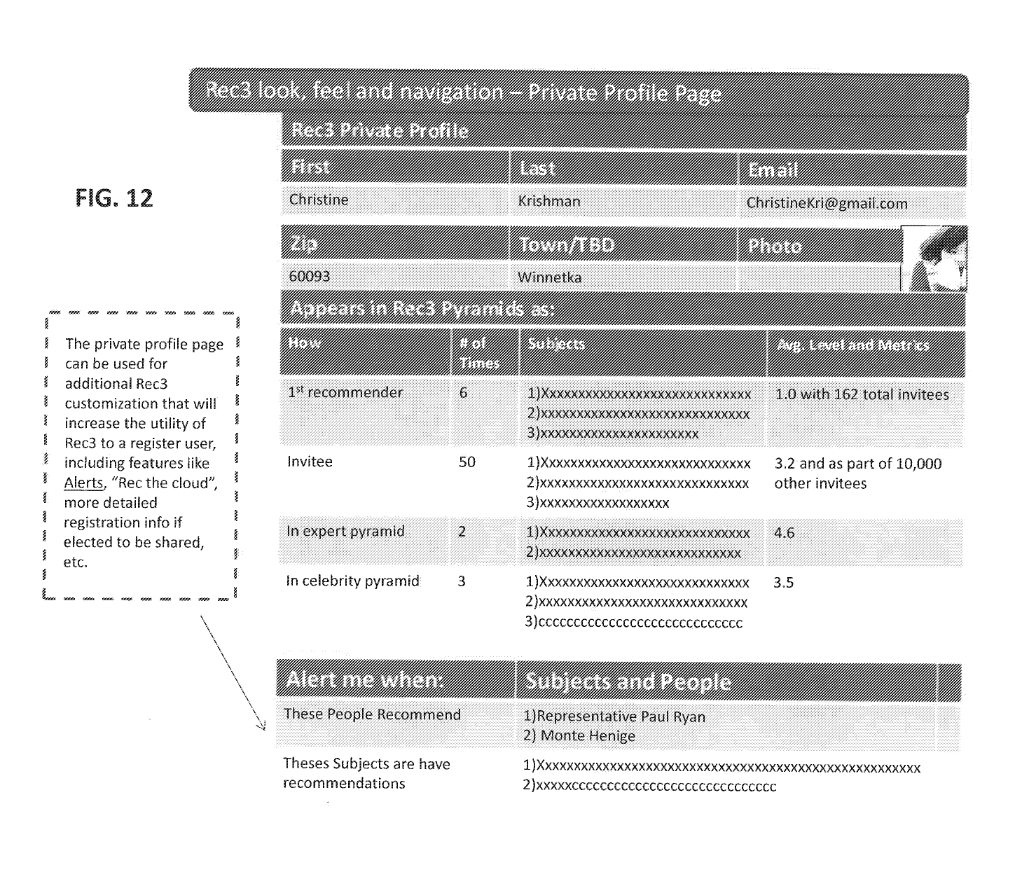

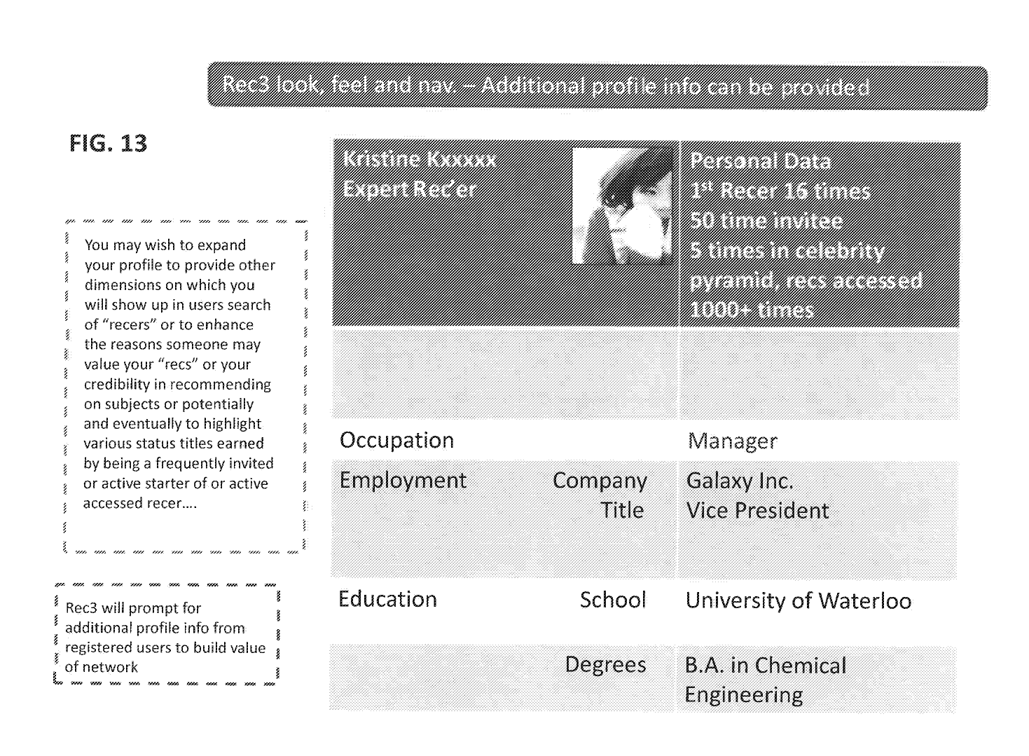

FIGS. 12-13: Private Profile
1. The private profile page can be used for additional Rec3 customization that will increase the utility of Rec3 to a register user, including features like Alerts, “Rec the cloud”, and more detailed registration info if elected to be shared.

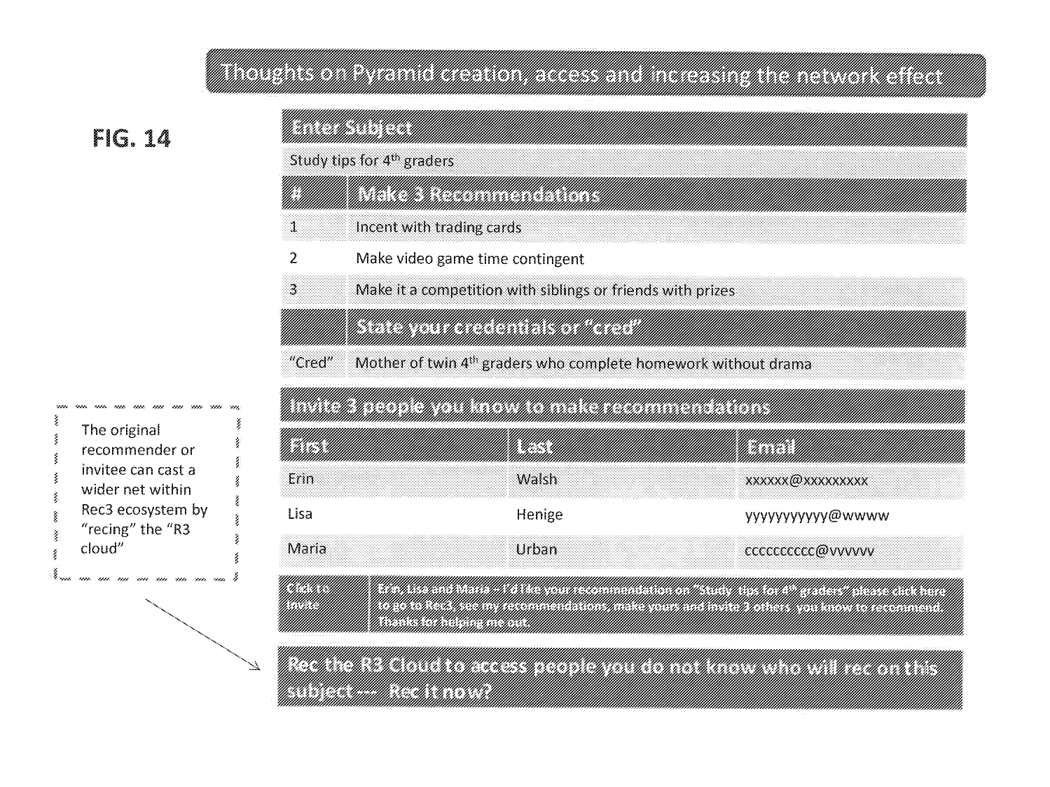

FIG. 14: Search Results Screen—Rec, Cred and Invite Entry Including “Rec the Cloud” Function
1. Some embodiments allow a user to ask all registered users, or some selected subset, of Rec3 to rec on the subject they are interested in.
2. Some embodiments include an algorithm to randomly send these invitations to a subset of the entire population. Another embodiment allows the user to specify characteristics of the people on the system that are invited to rec—they may be specified by any of numerous criteria (e.g., ask all experts on automobile related subjects to provide a recommendation on “best new sedan under $30K”).
3. Recers can “rec the cloud” only if they have first invited 3 people to recommend
4. In some embodiments recommendations generated by this function are structured in the form of a pseudo pyramid linked to the recer that invoked the function.
   Selected attributes that may be stored, maintained, associated with individual responders/recers, and may be specified to select or identify suitable responders:
a. # of Pyramids=total number of pyramids recer is a part of
b. # of times 1^{st} recer=number of times the recer has started a pyramid or recommended and invited others
c. # of invites=number of people recer has invited to Rec3
d. # of times invited or “invitee”=number of times recer has been invited to rec on a subject
e. # of expert Pyramids=number of times recer part of pyramid with expert(s), which is 100% once the system calculates a score that is >=to Expert level
f. # of celeb Pyramids=number of times recer part of pyramid with celeb(s), n/a if recer is a celeb
g. # of rec views=number of times a user of the system (member or casual user) has looked at recer's recommendations
   Embodiments of the invention will also find utility when practiced in mobile embodiments, and specifically with mobile computers, with examples including smart phones, tables computers, portable games, and the like.

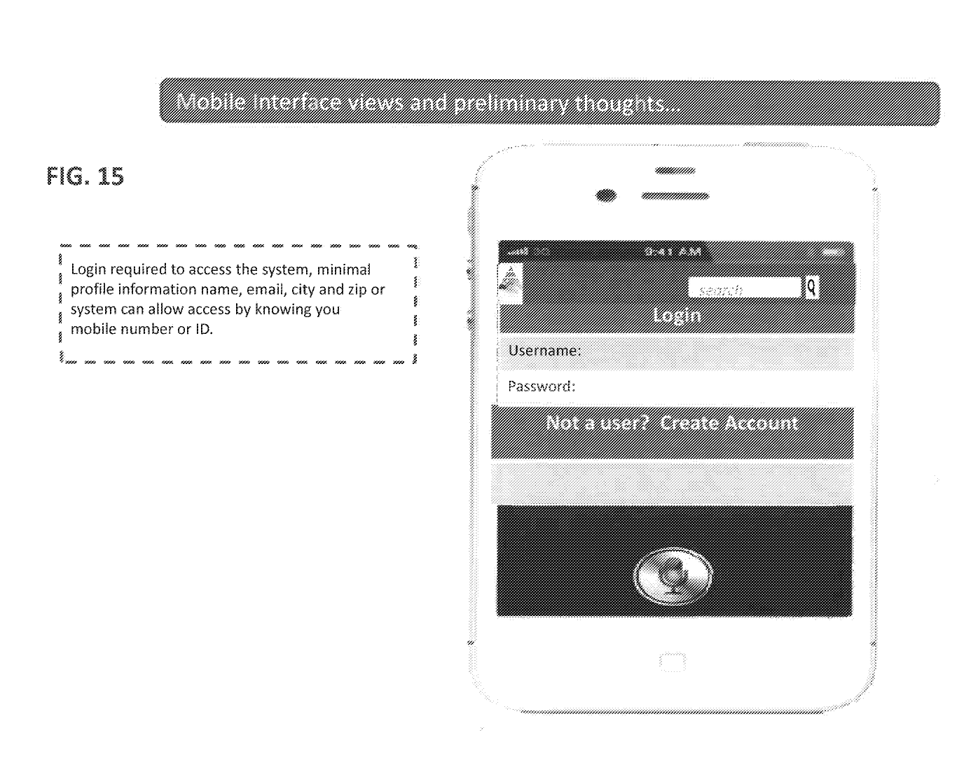

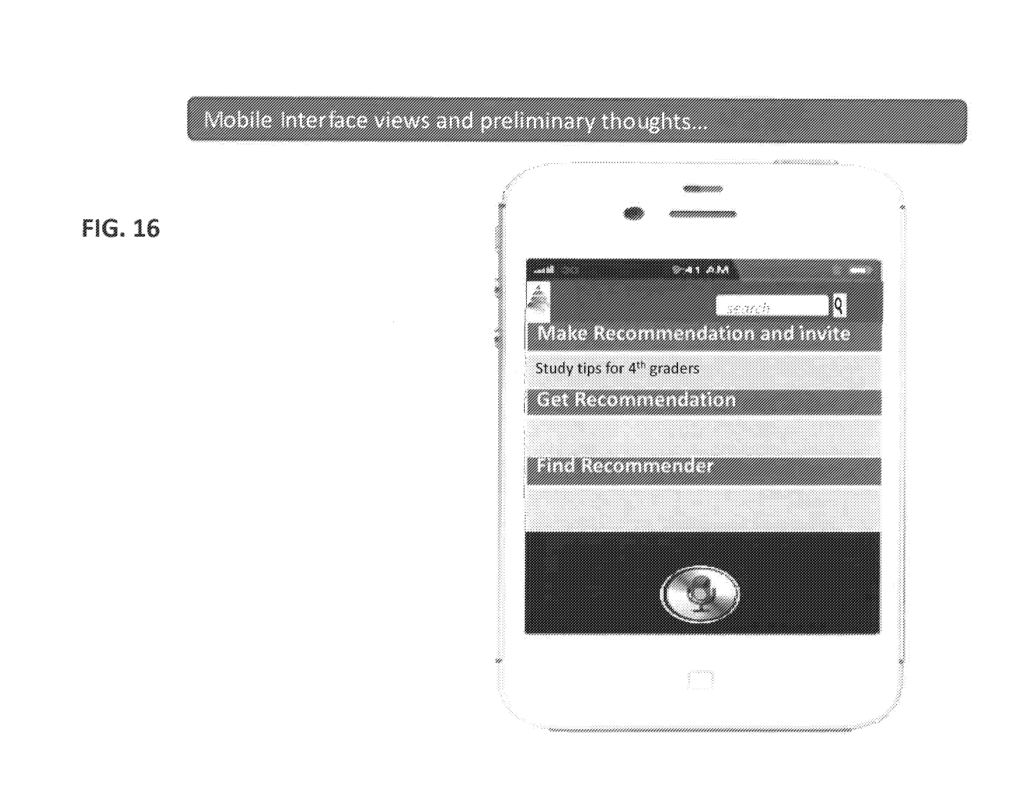

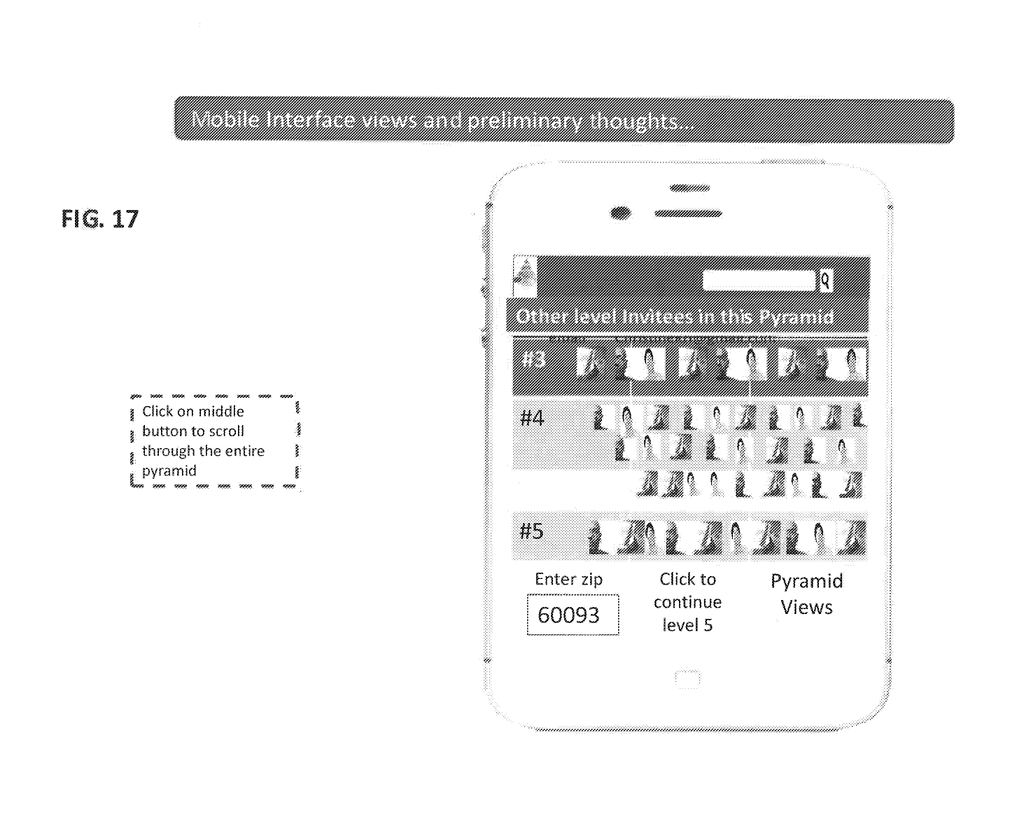

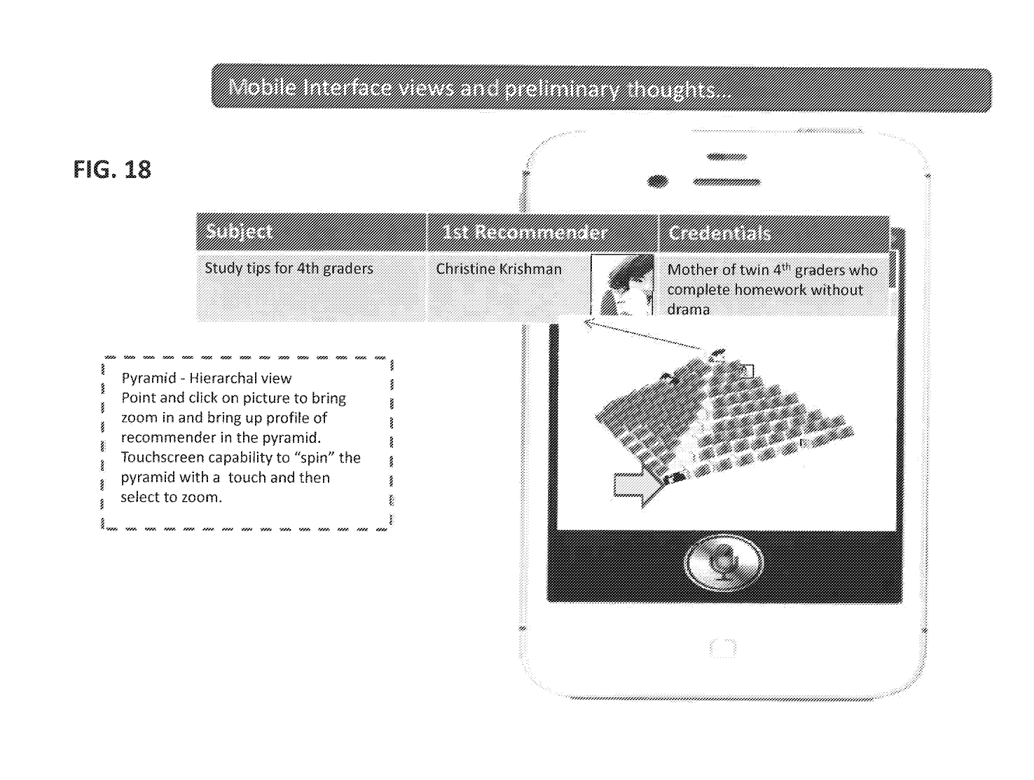

FIGS. 15-18 illustrate various aspects of such embodiments.

### B. Second Set of Example Embodiments

Still another set of example embodiments of the invention are described below by way of further illustration of the overall scope of invention. In order to consider these embodiments, definition of various terms will be useful.

### DEFINITIONS

Recho—1. The network of interrelated communication queries and responses created by a member starting a topic, writing recommendations and inviting others to recommend, as well as the informational graphical user interface to this network created in Rechoes (“Rechoes” referring to an overall embodiment in the form of a website, for example). Examples: Rechoes created, rechoes invited to; 2. Recommendations written by members on a topic they create or are invited to recommend on
Subject—a statement written by a member when starting a new recho.
Creator—person who starts or creates the recho by writing the topic, cred statement making first three recommendations and inviting three others. May also be referred to as a requestor or a first or initial requestor.
Invitee—a person invited by a member to join a recho by offering their recommendations on the topic and inviting others to do the same. May also be referred to as a responder after they have provided a recommendation/response.
Rechoer—a person that 1) has an account with Rechoes.com and 2) has either created a recho(es) or has responded to invitations to recho by submitting cred and recommendation statements on a subject(s)
Cred—Credibility or credential statement written by a recommender when recommending on a topic.
Reciprocity: Term used in psychology and other fields describing the repayment of some form of consideration in return for the receipt of some consideration. As an example, when a favor is done for a first person by a second, the first person may feel an obligation to do a similar or larger favor for the second person in return. It has been discovered that Reciprocity relates to Rechoes in that second users respond to invitations from first users to participate, which results in the first users feeling obligated to reciprocate to the second user's subsequent request. When someone you know invites you to give your opinion and be in on a recho with other people, you feel obligated to return the favor by responding to the invitation and answering the request. It has been discovered that this leads to an increased level of participation in Rechoes embodiments.

### Example Data Tables

In the below discussion reference will be made to the example Data Tables presented below to further illustrate invention embodiments. It will be appreciated that these example Tables are one illustration of example embodiment features only, and is not intended to limit the scope of the invention. As an example, various arrangements of stored data, field names, and other specific features of the Tables may easily be altered in other invention embodiments.

For example, in addition to the example Tables, data may be stored, organized and retrieved from tables and databases having alternate organizational schema. The database underlying Rechoes is a system of tables with fields to store information provided by users about themselves and subjects, cred statements, their invitees and recommendations they input. Email addresses used to invite people to recho and/or uploaded by members and other data specific to members and their activities in the system is stored. Certain statistics about the information are calculated and stored; for example counts of the number of rechoes a person has started.

The database tables are linked through three primary fields: 1. Rechoer ID, 2. Recho ID and 3. Recommendation ID. In addition each major data table has an associated table of attributes which allow for indexing, sorting and categorization of certain information contained in those tables. The attribute tables allow for definition of a particular person or element in the system, specifically a rechoer, recho and recommendation along as many dimensions as can be devised. A master attribute table lists all attributes utilized in the individual attribute tables.

For example if a user has established an account to enable them to log into the system via their credentials from another social network the database would store a record of this occurrence by matching an attribute ID (e.g., Facebook) with a Recho_ID (e.g., an individual in the system) and a Rechoer_Attribute_ID for tracking. The data underlying these actions is stored in the relevant database tables and is tied together via the attribute table.
The attribute structure also allows for easy additions of features and changes to the system. Attribute tables provide linkage to executable code within various modules of code residing on the server which allows for an underlying table to be changed without changing pieces of code itself Duplication of code in different modules can also be reduced through the use of attribute tables.
In other invention embodiments other database structures, fields and attributes may be utilized. For example a recommendation attribute could be a media file of a particular type which would be described in the attribute master table and executed via the Recommendation Attribute table:

### Master Attribute Table:

| Attribute_Id | Attributename | AttributeType |
|---|---|---|
| 14 | Video_File | varchar |

### Recommendation Attribute Table:

| Recommendation_Attribute_Id | Attribute_Id | Rechoer_Id | Attribute_Value |
|---|---|---|---|
| 1 | 14 | 1 | https://rechoes.com/Video.avi |

Other example embodiments of this structure are to allow rechoers to be available to other members to respond to rechoes on specific subjects, or be present as avatars or other virtual presences when logged into Rechoes. Still other example embodiments take steps to allow rechoers to specify how their rechoes are displayed to other users, including setting their rechoes as public or private.
As discussed herein above, various methods, systems and program products of the invention create, update, access and otherwise utilize stored data. Data may advantageously be organized in databases or tables according to an organizational schema that is useful in practicing various invention embodiments. Various example tables are presented below that will be useful in further considering invention embodiments, including in considering the discussion of particular invention embodiments presented above and herein below. Development and use of these Tables will be apparent to those knowledgable in the art.

### Additional Sample Data Tables

| No. 01 | Table Name: Rechoer |
|---|---|
| Description: | Table to store recommenders/site users information |

| Column Name | Data type | Constraint | Description |
|---|---|---|---|
| Rechoer_Id | int | PK | |
| First_Name | varchar | | |
| Last_Name | varchar | | |
| Email | Varchar | | |
| Password | varchar | | Stored in hash format |
| Zip | varchar | | |
| Town/City | varchar | | |
| State_Id | int | FK - State | |
| Photo | varchar/binary | | Can be varchar if we are storing |
| | | | path or binary if we are storing |
| | | | image. |
| Biography | varchar | | |
| Rank_Id | int | FK - Rank | To be updated whenever the |
| | | | rechoer creates a recho or |
| | | | makes a recommendation |
| Has_unsubscribed | tinyint | | To unsubscribe alert |
| Is_Active | tinyint | | |
| Is_Deleted | tinyint | | |
| Rechos_Created | int | | Count to be updated everytime |
| | | | a user created a recho |
| Rechos_Joined | int | | Count to be updated everytime |
| | | | a user joins a recho |
| Date_Last_Login | datetime | | |
| Date_Created | datetime | | |
| Source | Varchar | | The email of the person who |
| | | | invited this user |
| Provider | | | Used for tracking whether login |
| | | | through facebook/twitter was |
| | | | done |
| Date_Terms_Agreed | Datetime | | Datetime when the terms |
| | | | checkbox was checked at the time |
| | | | of registration |

| No. 02 | Table Name: Rechoer_Attribute |
|---|---|
| Description: | Table to store Rechoer Attributes |

| Column Name | Data type | Constraint | Description |
|---|---|---|---|
| Rechoer_Attribute_Id | Int | PK | |
| Rechoer_Id | Int | FK - Rechoer | |
| Attribute_Id | Int | FK - Attribute master | Id of the |
| | | | Attribute |
| Attribute_Value | varchar | | Content to |
| | | | be stored |

Sample Content of Table Rechoer_Attribute

| Rechoer_Attribute_Id | Attribute_Id | Rechoer_Id | Attribute_Value |
|---|---|---|---|
| 1 | 1 | 1 | www.facebook.com |
| 2 | 2 | 1 | www.linkedin.com |
| 3 | 3 | 1 | www.twitter.com |
| 4 | 4 | 1 | 1 |
| 5 | 5 | 1 | 0 |

| No. 03 | Table Name: Recho |
|---|---|
| Description: | Table to store rechoes/topics created by rechoers/users |

| Column Name | Data type | Constraint | Description |
|---|---|---|---|
| Recho_Id | int | PK | |
| Title | varchar | | |
| Date_Created | datetime | | Date on which recho |
| | | | is added |
| Rechoer_Id | int | FK - | Id of recommender |
| | | Rechoer | who added the subject |
| Is_Active | tinyint | | |
| Is_Withdrawn | tinyint | | |
| Recommendation_Count | int | | Counter to keep a |
| | | | count of |
| | | | recommendations |
| | | | received - added |
| | | | to avoid joins |
| Invitee_Limit | Int | | The setting of invitee |
| | | | limit at the time of |
| | | | recho creation. If |
| | | | the invitee limit is |
| | | | changed from 3 to |
| | | | 4 in future, the limit |
| | | | could be different |
| | | | for rechoes. Hence |
| | | | having this field will |
| | | | take care of that |
| | | | scenario. |

| No. 04 | Table Name: Recho_Attribute |
|---|---|
| Description: | Table to store Recho Attributes |

| Column Name | Data type | Constraint | Description |
|---|---|---|---|
| Recho_Attribute_Id | Int | PK | |
| Recho_Id | Int | FK - Recho | |
| Attribute_Id | int | FK - Attribute | id of the Attribute |
| | | master | |
| Attribute_value | varchar | | Content to be stored |

Sample Content of Table Recho_Attribute

| Recho_Attribute_Id | Attribute_Id | Rechoer_Id | Attribute_Value |
|---|---|---|---|
| 1 | 10 | 1 | 0 |
| 2 | 11 | 1 | 1 |

| No. 05 | Table Name: Recommendation |
|---|---|
| Description: | Table to store the recommendations received on a |
| | recho/topic |

| Column Name | Data type | Constraint | Description |
|---|---|---|---|
| Recommendation_Id | int | PK | |
| Recho_Id | int | FK - Recho | Id of the subject |
| Rechoer_Id | int | FK - Rechoer | Id of the recommender |
| Credibility | varchar | | Credibility of the rechoer for |
| | | | this recho. |
| Rec_1 | varchar | | The recommendation |
| | | | provided. |
| Rec_2 | varchar | | The recommendation |
| | | | provided. |
| Rec_3 | varchar | | The recommendation |
| | | | provided. |
| Custom_Message | varchar | | Custom Message |
| Date_Created | datetime | | Date on which |
| | | | recommendation was |
| | | | provided. |
| Pyramid_Level | Varchar | | Level of the pyramid where |
| | | | the rechoer falls e.g. 2.3 (2^{nd} |
| | | | level, 3^{rd} position) etc. |
| ParentRechoer_Id/Inviter_ID | int | FK - Rechoer | Id of the rechoer who had |
| | | | invited this rechoer. |
| Dt_LastAccessed | datetime | | Date on which recho was |
| | | | last visited by the user—for |
| | | | decreasing count on alerts |
| | | | popup |
| Is_Deleted | tinyint | | Flag to mark the |
| | | | recommendation as |
| | | | deleted. Admin can delete a |
| | | | recommendation if any |
| | | | abusive content is posted. |

| No. 06 | Table Name: Recommendation_Attribute |
|---|---|
| Description: | Table to store Recommendation Attributes |

| | Data | | |
|---|---|---|---|
| Column Name | type | Constraint | Description |
| Recommendation_Attribute_Id | Int | PK | |
| Recommendation_Id | Int | FK - | |
| | | Recom- | |
| | | mendation | |
| Attribute_id | int | FK - | id of the |
| | | Attribute | Attribute |
| | master | | |
| Attribute_Value | varchar | | Content to be |
| | | | stored |
| Status | Enum | | To track |
| | | | whether this |
| | | | invitee |
| | | | responded or |
| | | | not |

Sample Content of Table Recommendation_Attribute

| Recom- | | | |
|---|---|---|---|
| mendation_Attribute_Id | Attribute_Id | Rechoer_Id | Attribute_Value |
| 1 | 7 | 1 | Abc@yahoo.com |
| 2 | 8 | 1 | rtx@yahoo.com |
| 3 | 9 | 1 | bzs@yahoo.com |

| No. 07 | Table Name: Rechoer_Contact |
|---|---|
| Description: | Table to store contacts of a rechoer/user |

| Column Name | Data type | Constraint | Description |
|---|---|---|---|
| Contact_Id | int | PK | |
| Rechoer_Id | int | FK - | Id of recommender to which |
| | | Rechoer | this contact belongs |
| First_Name | varchar | | |
| Last_Name | varchar | | |
| Provider | char | | (Y, F, G) for three predefined |
| | | | providers |
| Email | varchar | | |
| Date_Created | datetime | | |
| Is_Deleted | tinyint | | |

| No. 08 | Table Name: Alert |
|---|---|
| Description: | Table to store the alerts set by a Rechoer |

| Column Name | Data type | Constraint | Description |
|---|---|---|---|
| Alert_Id | Int | PK | |
| Rechoer_Id | int | FK - Rechoer | Rechoer for whom alert is |
| | | | set |
| Attribute_Id | int | FK - Attribute master | id of the Attribute |
| Attribute_Value | varchar | | Content to be stored |
| Date_Created | datetime | | |

Sample Content of Table Alert

| Alert_Id | Attribute_Id | Rechoer_Id | Attribute_Value | Date_Created |
|---|---|---|---|---|
| 1 | 13 | 1 | 1 | 8/10/2012 |
| 2 | 14 | 1 | 1 | 8/10/2012 |
| 3 | 15 | 1 | Adventure | 8/10/2012 |

| No. 09 | Table Name: Rank |
|---|---|
| Description: | Table to store user levels and their colors |

| | | Con- | |
|---|---|---|---|
| Column Name | Data type | straint | Description |
| Rank_Id | int | PK | |
| Rank | varchar | | Expert/Celeb/gold/silver/blue |
| Color | varchar | | Expert - purple, celeb - green, |
| | | | gold, silver, blue |
| Lower_Limit | int | | Lower limit for determining gold, |
| | | | silver, blue. Gold - 300+, Silver - |
| | | | 20-299, Blue - 0-49 rehoes |
| Upper_Limit | int | | Upper limit for determining gold, |
| | | | silver, blue. Gold - 300+, Silver - |
| | | | 20-299, Blue - 0-50 rehoes |
| Date_Created | Datetime | | |

| No. 10 | Table Name: Notification |
|---|---|
| Description: | Table to store the notifications sent to remind invitees |
| | who have not responded. |

| Column Name | Data type | Constraint | Description |
|---|---|---|---|
| Notification_Id | Int | PK | |
| Recho_Id | int | | The recho for which a |
| | | | notification was sent |
| Rechoer_Id | Int | | The rechoer for which a |
| | | | notification was sent |
| Email | varchar | | If the id is not known i.e. |
| | | | invitee hasn't joined yet |
| Date_Created | datetime | | |

| No. 11 | Table Name: Rechoer_Activity |
|---|---|
| Description: | Table to store user's activities |

| Column Name | Data type | Constraint | Description |
|---|---|---|---|
| Activity_Id | Int | PK | |
| Rechoer_Id | int | FK - Rechoer | |
| Recho_Id | Int | FK - Recho | |
| Activity | varchar | | Activity performed by |
| | | | the user |
| Date_Created | datetime | | |
| Activity_Type | Varchar | | Recording type of activity - |
| | | | recho, profile etc. |
| Admin_Id | Int | | If changes made by admin |
| | | | store admin id |

| No. 12 | Table Name: Search_Log |
|---|---|
| Description: | Table to log every search for a recho/rechoer |

| Column Name | Data type | Constraint | Description |
|---|---|---|---|
| searchlogid | int | PK | |
| Searched_By | int | FK - Rechoer | |
| Date_Created | datetime | | |
| Searched_Term | Varchar | | |

| No. 13 | Table Name: Customer_Service |
|---|---|
| Description: | Table to store contact us and customer service requests |

| Column Name | Data type | Constraint | Description |
|---|---|---|---|
| CS_Id | Int | PK | |
| First_Name | varchar | | |
| Last_Name | varchar | | |
| Email | varchar | | |
| Description/Message | varchar | | |
| Request_Type | Varchar | | CS or CU |
| Contact_Purpose | varchar | | |
| Rechoer_Id | int | FK - rechoer | |
| | | Allow null | |
| Date_Created | datetime | | |
| Date_Modified | Datetime | | |
| Date_Responded | Datetime | | |
| Responded_By | | | |
| Responded_Text | varchar | | Text responded by |
| | | | admin |

| No. 14 | Table Name: Country |
|---|---|
| Description: | Table to store country list |

| Column Name | Data type | Constraint | Description |
|---|---|---|---|
| Country_Id | int | PK | |
| Name | varchar | | |
| Iso_code_2 | varchar | | 2 digit country code |
| Iso_code_3 | varchar | | 3 digit country code |

| No. 15 | Table Name: State |
|---|---|
| Description: | Table to store state list |

| Column Name | Data type | Constraint | Description |
|---|---|---|---|
| State_Id | int | PK | |
| Country_Id | int | FK - Country | |
| Name | varchar | | |
| Code | varchar | | |

| No. 16 | Table Name: Recommend_Friend |
|---|---|
| Description: | Table to store recommended friend list |

| Column Name | Data type | Constraint | Description |
|---|---|---|---|
| Recommend_Friend_Id | Int | PK | |
| Rechoer_id | int | FK - Rechoer | |
| First Name | Varchar | | First name of the person who is |
| | | | recommending the site |
| Last Name | Varchar | | Last name of the person who is |
| | | | recommending the site |
| Email_Source | varchar | | Email address of the person who |
| | | | is recommending the site |
| Email_Target | varchar | | Email address of the users being |
| | | | recommended the site |
| Custom_Message | varchar | | |
| Date_Created | datetime | | |

| No. 17 | Table Name: CMS |
|---|---|
| Description: | Table to static pages content |

| Column Name | Data type | Constraint | Description |
|---|---|---|---|
| Content_Id | int | PK | |
| Page_Title | varchar | | |
| Page_Desc | varchar | | |
| Page_Content | Long text | | |
| Meta_Tags | varchar | | |
| Date_Created | Datetime | | |
| Date_tModified | Datetime | | |
| Modified_By | | FK | |

| No. 18 | Table Name: System_Setting |
|---|---|
| Description: | Table to System Settings |

| Column Name | Data type | Constraint | Description |
|---|---|---|---|
| Setting_Id | int | PK | |
| Key | varchar | | |
| Value | varchar | | |
| Date_Created | Datetime | | |
| Date_Modified | Datetime | | |

| No. 19 | Table Name: Social_Share |
|---|---|
| Description: | Table to store social share recommendation |

| Column Name | Data type | Constraint | Description |
|---|---|---|---|
| Socialshare_id | int | PK | |
| Rechoer_id | int | FK - Rechoer | |
| Social Network | varchar | | Facebook, Twitter & |
| | | | Google + |
| Recho_Id | | | |
| Content_Shared/ | Varchar | | |
| Message | | | |
| Date_Created | Datetime | | |

| No. 20 | Table Name: Attribute_Master |
|---|---|
| Description: | Table to store details for all possible attributes |

| Column Name | Data type | Constraint | Description |
|---|---|---|---|
| Attribute_Id | Int | PK | |
| Attribute_Name | varchar | | Name of the Attribute |
| Attribute_Type | Varchar | | Data Type of the |
| | | | attribute |

Sample Content of Table Attribute_Master

| Attribute_Id | Attributename | AttributeType |
|---|---|---|
| 1 | FacebookUrl | Varchar |
| 2 | LinkedInUrl | Varchar |
| 3 | TwitterUrl | Varchar |
| 4 | IsExpert | Tinyint |
| 5 | IsCelebrity | Tinyint |
| 6 | IsAdmin | Tinyint |
| 7 | Invitee | Varchar |
| 8 | HasCeleb | Tinyint |
| 9 | HasExpert | Tinyint |
| 10 | Alert_Rechoer_Id | Int |
| 12 | Alert_RechoId | Int |
| 13 | Alert_Keyword | Varchar |

| No. 21 | Table Name: rechoer_email_alias |
|---|---|
| Description: | Table to store email aliases for a rechoer |

| Column Name | Data type | Constraint | Description |
|---|---|---|---|
| Rechoer_Email_Alias_ID | Int | PK | |
| Rechoer_Id | int | FK | Rechoer id |
| Email | varchar | | Email alias |
| Status | Varchar | | Status of email |
| | | | alias added i.e. |
| | | | new, verified etc. |
| Date_Created | datetime | | Date on which the |
| | | | alias got added |
| Date_Verified | datetime | | Date on which |
| | | | the alias got verified |
| No_Of_Attempts | Int | | Store number of |
| | | | times a |
| | | | recommendation |
| | | | was made with |
| | | | an alias |
| Is_Deleted | Int | | If deleted |

| No. 22 | Table Name: temp_recent_rechoes |
|---|---|
| Description: | Table to store recent rechoes for a temporary time period to |
| | reduce table joins |

| | | Con- | |
|---|---|---|---|
| Column Name | Data type | straint | Description |
| Recho_Id | int | PK | Recho id |
| Title | varchar | | Recho title |
| Rechoer_Id | int | FK - | Id of recommender who added |
| | | Rechoer | the subject |
| First_Name | varchar | | First name of recommender |
| Countrec | Int | | Number of recommendations |
| | | | received |
| Last_Name | varchar | | Last name of recommender |
| Photo | varchar/ | | Can be varchar if we are storing |
| | binary | | path or binary if we are storing |
| | | | image. |
| Color_Class | | | |
| Rechos_Created | int | | Rechoes created by rechoer |
| Rechos_Joined | int | | Rechoes joined by rechoer |
| Credibility | varchar | | Credibility of the rechoer for this |
| | | | recho. |
| Rec_1 | varchar | | The 1^{st} recommendation |
| | | | provided. |
| Rec_2 | varchar | | The 2^{nd} recommendation |
| | | | provided. |
| Rec_3 | varchar | | The 3^{rd} recommendation |
| | | | provided. |
| Date_Updated | datetime | | Date on which the table was last |
| | | | updated |

Additional Database Indexes and/or tables are created as needed and identified during embodiment operation.

### Summary of Invention Embodiment

### Rechoes System

Having now described some definitions and underlying data storage and organization features of some embodiments, the overall operation of an example embodiment may be discussed. “Rechoes” is a name used for convenience to describe another example embodiment. It may be embodied in a method, a system, and or a computer program product stored on a non-transitory memory for causing one or more computers to take various actions including utilizing executable instructions to obtain and store information from rechoers, their invitees, including recommendations, cred statements and personal information. In one example embodiment, Rechoes is embodied in program instructions on a network that are operative to create an internet website useful to execute the invention embodiment.

### Engagement and Use of Rechoes

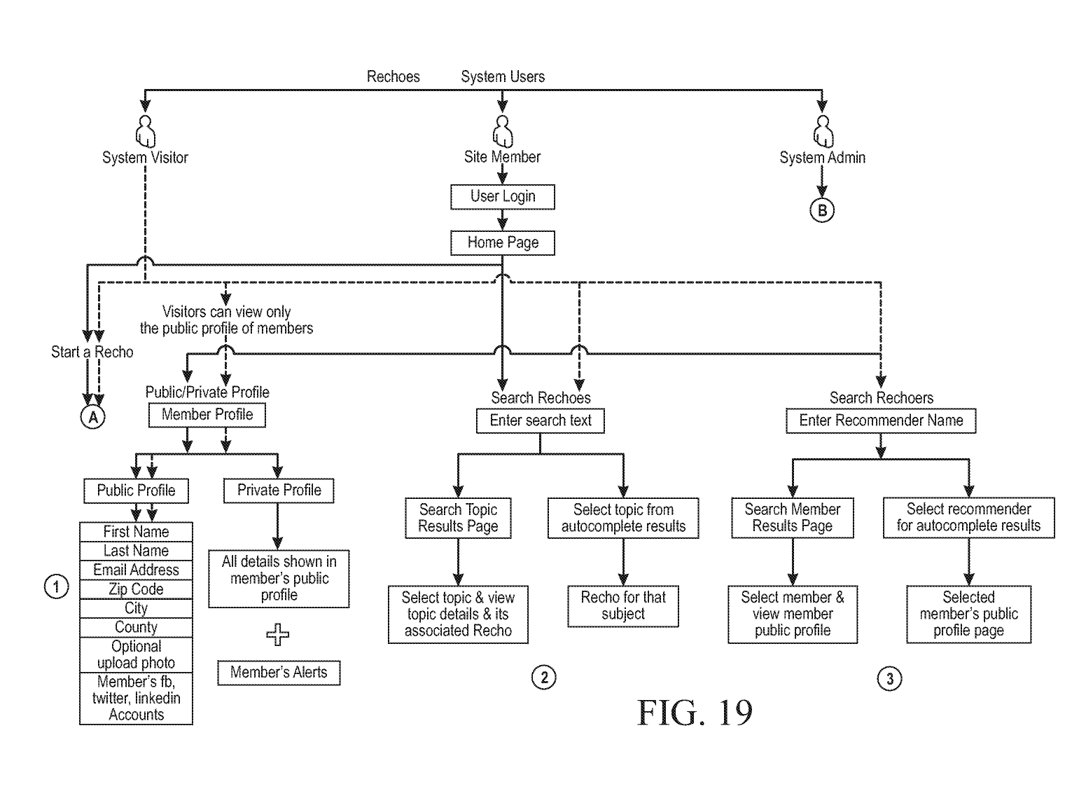

A flow chart of some (but not all) potential processes of the Rechoes system appears in FIG. 19 below. Users navigating to the site have options to either search subjects (rechoes) or people (rechoers) utilizing built-in key word search. Users also may start a new recho. Users may communicate with Rechoes via a network such as the internet, by using local devices such as a computer, mobile processor based device (including a wireless smart phone, for example) and the like.
When a person (creator or requester) starts a new recho, they inform the system (which may be, for example, a central server executing a program product of the invention) whom to invite from their own personal and professional email address books. The system sends each “invitee” an electronic message (that may be, for example, a text message, voice message, an e-mail or other communication) with a link (which may be a URL, an IP address, network address, or other electronic address) directly back to Rechoes and upon clicking the link (or otherwise selecting the address) an invitee will be directed (for example, land on an internet webpage) which enables them to register if new to the system or sign in and offer their own opinions or recommendations, a statement about their credibility (cred) and invite 3 others to the recho.
Important aspects of the system that enable the collection and display of content include that:
All subject, cred and recommendation statements are limited to 100 characters or less
Members can upload electronic address (for example, email address) lists to the system and the system captures addresses they invite to recho
The invite only aspect enables linking of people to each other, subjects they weigh in on and their opinions and cred statements
   In the figure below select boxes are annotated with a number e.g., \textcircled{2} to enable explanation of server and database functions that enable users to join Rechoes, search and display content and start new rechoes. These steps may be performed by a computer system, by a program product, or may be steps of a method. The section entitled “Server and database functionality” provides a more detailed explanation of how the example system or program product executes its functions.
   A user of the system may or may not choose to register an account on the system. Any user can browse and search content on the site that is available to the public. Users must register in order to start a recho, with registration including the user providing basic identification and other requested information and selecting a User ID.
   At this point a person who is already a member of Rechoes (i.e., who has already gone through a registration process) may sign in and access their Private Profile (i.e., stored personal data). The Private Profile can be edited to allow the member to provide additional data about themselves, manage alerts set in the system, upload email or other electronic address contacts from address books, and otherwise store additional personal information or edit existing information.
   Another feature allows members to create email aliases or other electronic addresses in effect subtending additional email addresses that they own that they would like the system to recognize as belonging to them. This feature allows a member to respond to any recho invitation from any email client or system that they use.

### Server and Database Functionality

The infrastructure supporting some embodiments of the Rechoes system are cloud-based web and application servers, load balancers and databases that may be accessed over a network, such as the internet, a WAN, a LAN, a wireless communications network, or the like. As users interact with Rechoes via communications devices linked to the network (computer, phone, smart phone, gaming device, pad device, other) application servers interact with numerous tables in a database in order to collect and store information for use in displaying content to users of the system.
Referring to FIG. 19 above:
\textcircled{1} User interface: Public profile allows read-only view of member identifying information (which may be one or more of first name, last name a photo or other image and other optional information like biographical summary and city, state).
   Server function: Application server code calls database tables to find name, rechoer activity, rechoes created and invited to and recommendation counts. This information is assembled real time when requested by the user interfacing with the web server. Certain counts and activities are cached by the web server and updated on a schedule to speed response after the initial server call during a particular browser session.
   Database Tables involved and function: Tables Recho, Rechoer, Recommendation and Rechoer Attribute are linked via a unique Rechoer ID and multiple Recho ID stored in non-transitory memory in databases. Databases may be stored on memories that are connected to and otherwise available over the network which may be the network that the server is located on.
\textcircled{2} User interface: Several options are given to users by the system to see content. From the Public profiles, users may click to see Rechoes Created and Rechoes Invited which comprise content that the user has started and contributed to. A search function allows users to type in a word which the system will use to find closest matches of subjects that have been created in Rechoes. This may be done, for example, by a text based search of data stored in one or more database.
   Server function: Application server code calls database tables to find rechoes and associated subject lines, recommendation counts and cred statements. This information is assembled real time when requested by the user interfacing with the web server. Certain counts and activities are cached by the web server and updated on a schedule to speed response after the initial server call during a particular browser session.
   Database Tables involved and function: Tables Recho, Rechoer, Recommendation and Rechoer Attribute are linked via a unique identifier, with an example being a Rechoer ID and multiple Recho ID stored in non-transitory memory in databases.
\textcircled{3} User interface: Users may select a radial button under the Search text box to search rechoers or people with accounts registered with Rechoes. Users type all or part of a name (first or last) and the system will drop down a list of possible matches. When a user makes a selection a Search Results page is displayed. The user then may click on an individual's name or image on this screen to access the individual's Public Profile.
   Server function: Application server code calls database table to find rechoers names to display in the drop-down list. This information is stored in transitory memory until user makes a selection. Once a selection is made server calls first name, last name and the image file associated with the selection to populate the Search Results screen. When user makes a selection form this page server assembles information as described in 1 above.
   Database Tables involved and function: Table Rechoer and an image storage container common to all servers on the infrastructure platform deliver first and last name and image associated with the selected user.

### Process to Create a Recho

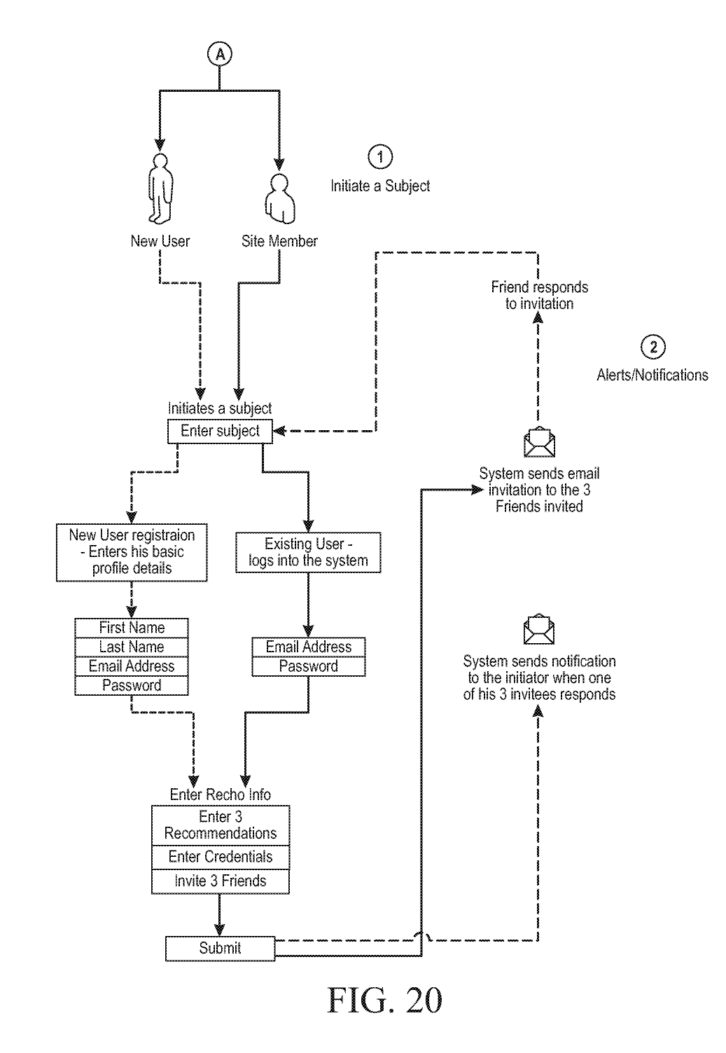

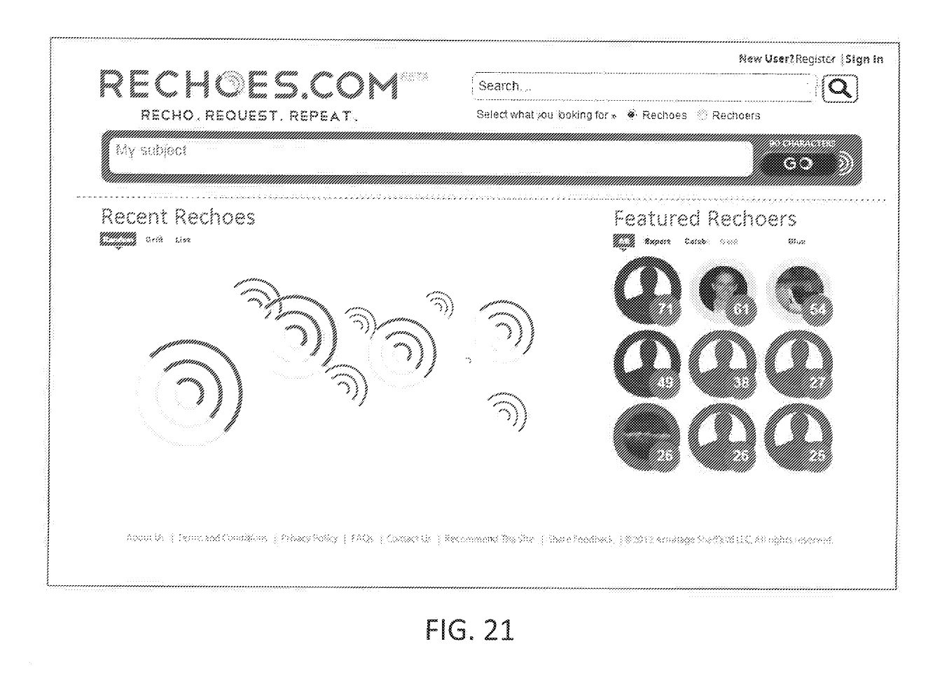

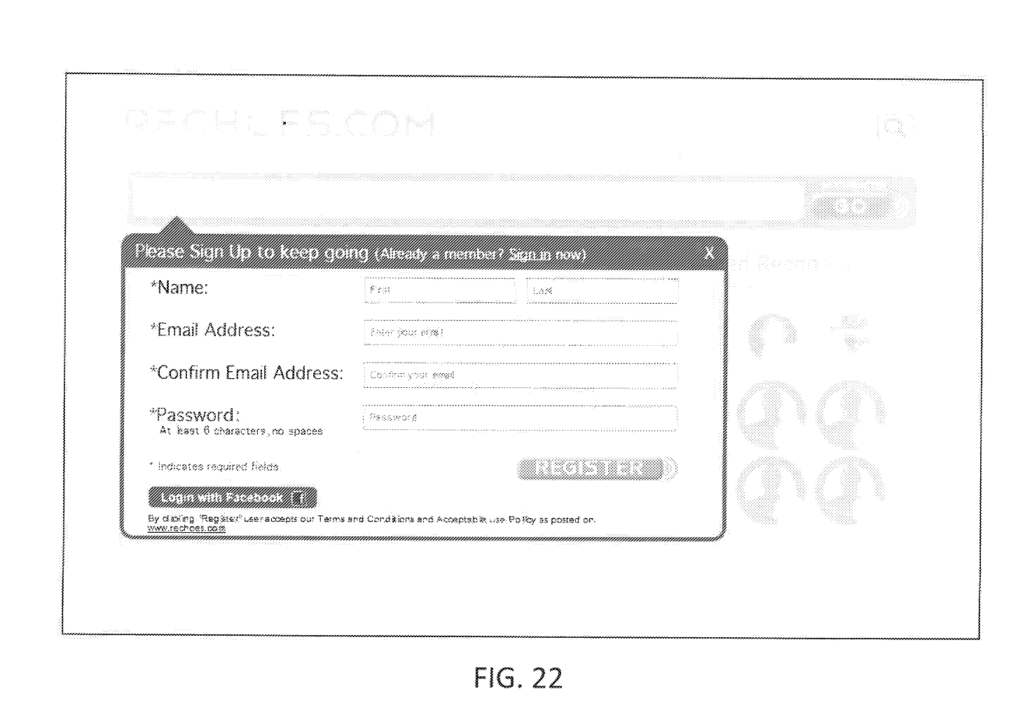

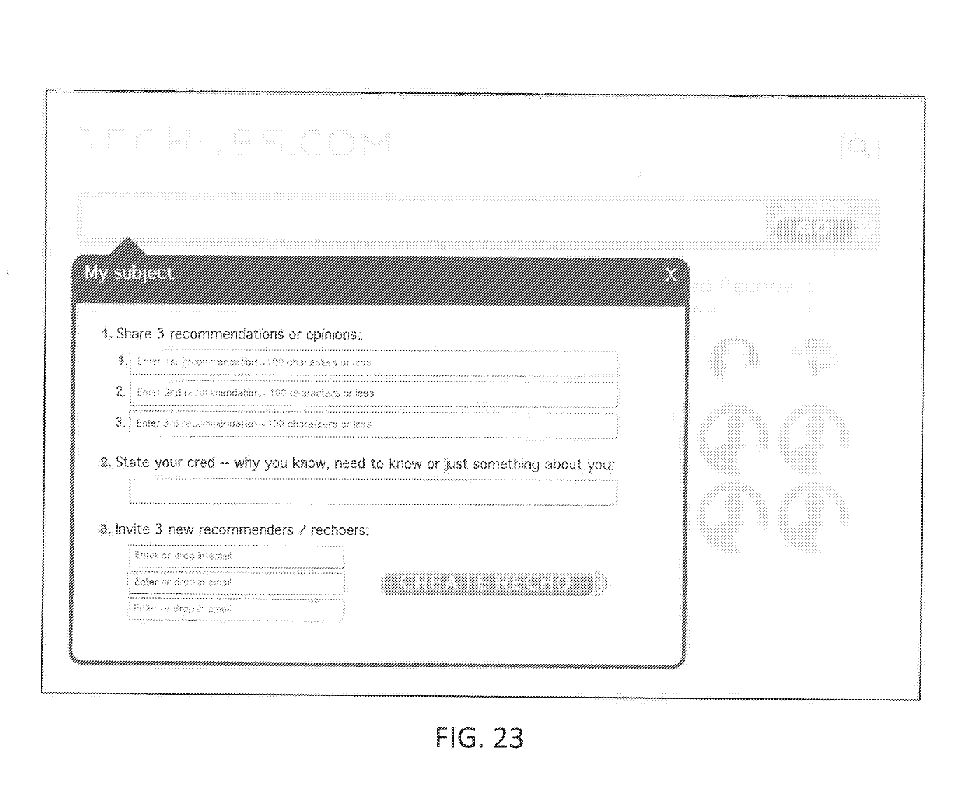

In FIG. 20 one example process flow to create a recho is depicted. The high level process is described briefly at a high level as follows:
1. User will enter Subject (100 characters or less)
2. User enters 3 of his own recommendations (mandatory fields) (micro-recommendations contain 100 characters or less)
3. User defines his own credentials in a concise manner (100 Characters or less), which actually defines why she is able to provide relevant opinions related to the topic
4. New users will invite friends by either importing their contacts or manually entering their mail ids. Members will choose their contacts from contacts imported in their contacts book
5. New users enter their profile information (which may be, for example, First Name, Last Name, Email, Country, Zip, Town & Profile picture). Some of these may be mandatory. As an example, profile picture, all other fields may be mandatory. Members will see these fields pre-populated upon their subsequent visit to the Site.
   In the following sections, screen shots from one example system embodiment combined with descriptions of user interaction with the interface and explanation of what the system is doing during these steps are used to elucidate.
1. Initiate a subject. Refer to FIG. 21 below.
User interface: User types a subject statement, 100 characters or less in the text box to left of “Go” button.
Server function: Web server capturing information communicating to application server once “Go” button is clicked. Data is not written to the database until the entire process is complete. A counter is kept of “characters left” in transitory memory by the application server. The subject is kept on the local machine until the process is complete or discarded if the process is interrupted before completion.
Database Tables involved: None
2. Register or log in. When the user clicks “Go” in step 1 above, a registration window opens as depicted in FIG. 22.
User interface: A new user completes this window; people who already have registered an account may click “Sign In” on this window to replace this window with a simple user name and password entry window.
Server function: Web server is delivering click information and application server code is acknowledging progress through the screens.
Database Tables involved: When the user clicks register, the application writes name and password created to Table Rechoer in the process creating a unique Rechoer ID.
3. Enter details. In FIG. 23 in order to complete the information for the recho users enter their opinions, cred statement and invite three others to the recho.
User interface: Text entered in the “recommendations” and “cred” text boxes are limited to 100 characters.
Server function: When “Join Recho” is clicked application server instructs data to be written to the database. The application displays a web-based graphic denoting that the recho was successfully created.
Database Tables involved: Data written to tables Recho, Rechoer, and Recommendation. Data is tied together via a Rechoer ID and Recho ID. An indexing schema kept in table Recommendation identifies the position or level a rechoer falls in the recho structure.

### Hierarchical Graphical Representation—Recho Structure

Invention embodiments include displays of hierarchical arrangements of answers with credential and identifier information on the corresponding responders. The hierarchical arrangement indicates the relation between the original question, initiating requestor and each geometrically removed level of responders such that the sequence of answers along the geometrically expanding chain of responders is represented graphically. This can be done in a number of different manners, with examples including a graphical tree structure, a network node diagram, other two or three dimensional graphs and charts, and the like.
One particular example embodiment is a network structure or infographical interface which shows the creator or originator of the subject at the top center of the figure. The creator's three invitees appear as nodes or shapes or images in a semi-circular arrangement featuring concentric 180° arcs under and around the creator and that are graphically connected to the creator using lines to indicate path of communications between levels. Given that each of the three invitees of the creator invites three people to the recho, they would be represented in the next level down/radially outward in a semicircular row below/around them and connected to the level above. This progression would continue as long as people continued to offer their opinions about the subject and invite more people to recho.
All the people who have been invited and have responded to the invitation to make recommendation on this topic will be a part of this recho. The recho will be separated by levels, where the initiator of the topic stands at level 1, and his invitees at level 2 and so on. An initial view of the recho may not display all the levels on one screen or page, since the recho can span up to multiple levels and in version 1 recho structures or views will be scrollable by the viewer. It has been discovered that this offers an elegant means for representing the organization and growth of a network.
In some embodiments, the recho would have gaps when people do not respond. The recho would die a natural death when people invited do not respond since the recho would fail to grow to further levels. In others, it may delete such gaps and adjust display to result in a “full” display regardless of the number of responders. Some system embodiments will set certain parameters or limits to establish a lifetime of a recho which may be, for example, a maximum time limit, a max number of levels, or the like. In some example embodiments, the recho elements or nodes would contain profile pictures or selected graphical images (icons, drawings, etc.) of the members of that recho.
Rechoes can be viewed by anyone, not just those that started them or appear as invitees. A user does not have to be a registered user to view most rechoes and their content. A person, however, cannot insert themselves into someone else's recho but must start their own should they want to offer an opinion on a subject in a recho into which they have not been invited. They also have to be a registered user in order to start or create a recho. In some embodiments users who want to weigh in on a particular subject who have not been invited to a recho will be able to click a link if they are “not invited to this recho and want to start one like it.”
In some embodiments, the user will be able to “mouse over” (moving a cursor over it) or otherwise select some portion of a recho, which may be, for example, an individual node representing one responder. Doing so will cause the display to change and to show recommenders' pictures and their credential statement and recommendations and/or other data (which may include, for example, other rechoes that user has participated in, rechoes ranking, and the like). Users will also be able to zoom in/out on specific selected recommenders and their invitees as they peruse the recho on the GUI. When they do so, the selected portion of the recho is magnified and may display additional data. Other actions include changing the perspective view of the display, with examples including rotating it, reversing it, expanding to three-dimensional view, and the like.
Some embodiments limit uses to inviting the number of responders or rechoers, with examples being no more than 2, no more than 3, no more than 4, no more than 5, and the like. The nature of limiting users to inviting some specific number, with an example being 3, other people to recommend or “recho” leverages strong social dynamics of exclusivity, feeling pleased to be in the “in” crowd that is asked their opinion, etc. but it does limit the network effect. In other embodiments in order to increase the network effect of Rechoes while preserving the benefits of a limited invite list an invite the “Rechoes cloud” feature allows a rechoer to also elect to invite the “Rechoes cloud” anonymously. The Rechoes cloud consists of registered users who have volunteered to offer their opinion on a variety of subjects should they be “rechoed” on and a “rechoer” or invitee selects to invite the “Rechoes cloud”. It is expected that many people will utilize this option both to augment the recommendations they receive and to build their reputation as a recommender or “rechoer”.
Some embodiments also provide logical cross linking between different rechoes. Graphical links connecting the same (or related) responders/rechoers, common or related questions, or the like may be provided. These may be, for example, lines connecting responder nodes. Repeated and regular searching by the server may be performed to identify cross-linked subject matter. In such circumstances, selecting a “show related” or similar icon may cause the system to display the related rechoes.
In some embodiments additional media is inserted as recommendation and cred statements or accessed from these fields in the recho structure. For example users are able to provide as recommendations audio, video and including but not limited to other multimedia and text-based files in the process of providing their recommendations. Any uploaded or attached files are managed from their personal profiles.
Additional communications technologies enable people in a particular recho, across similar rechoes, or in other instances to contact each other from within the system. Internal email, texting, instant messaging and other electronic communication technologies may be used. Business rules for types and methods of communication are created within the system which is driven by member preferences.

### Recho Statistics

System embodiments will maintain certain Statistics on each of the rechoes inclusive of but not limited to:
1. No. of Recommenders in the recho
2. No. of Recommendations in the recho
3. No. of levels (e.g., rings shown in the GUI) of the recho
4. No. of times the recho has been accessed by searching the site and system

### Speed of Recho Creation/Interrelation

Some embodiments create graphical links across multiple recho to indicate common or related recommenders, along with related questions or answers. Again, searching by the server to identify opportunities for such cross linking is performed on a regular and repeated basis, and may be text based searching. Some embodiments use this and related features to show users the “network effect” of recommenders interacting with the system to pose topics, write recommendations and invite others to do the same.

### Search and Display Recho Structures

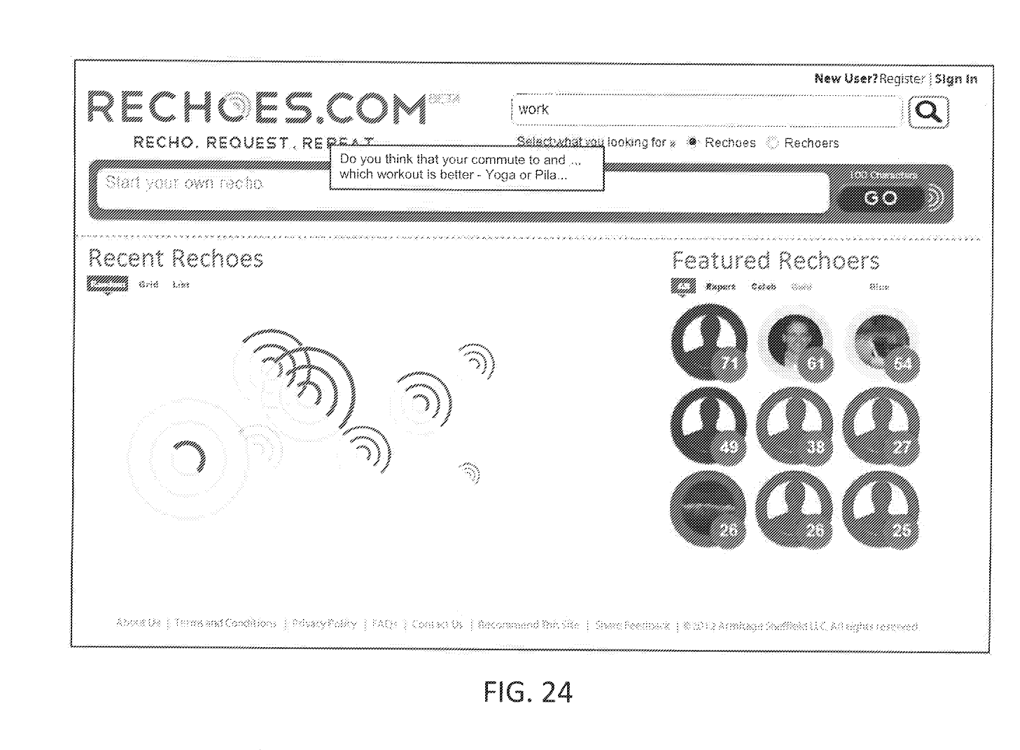

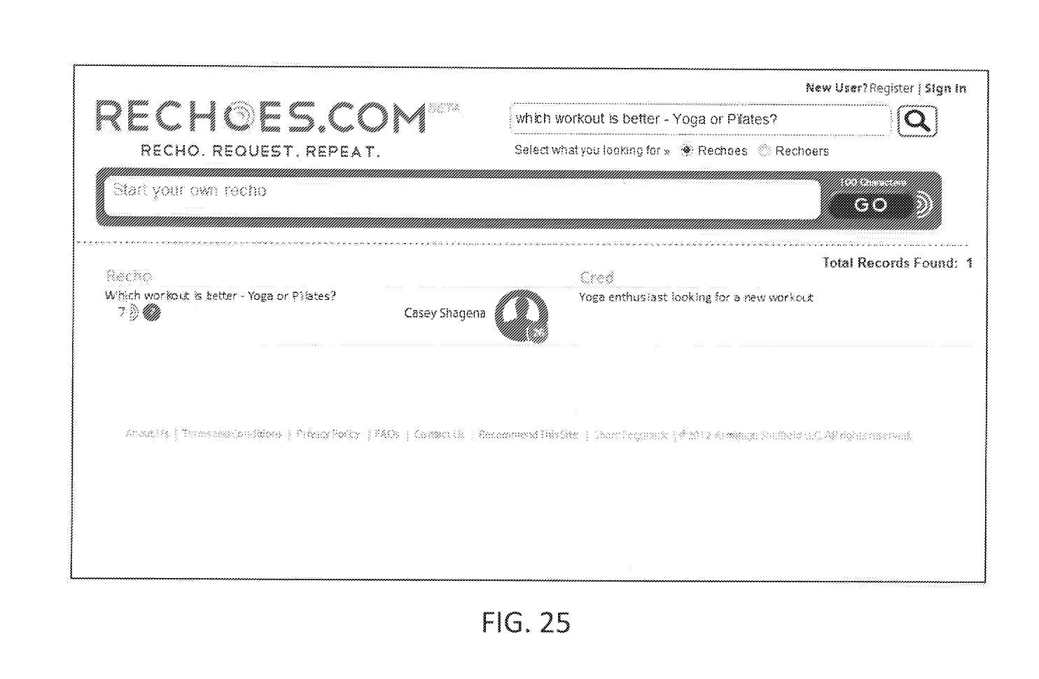

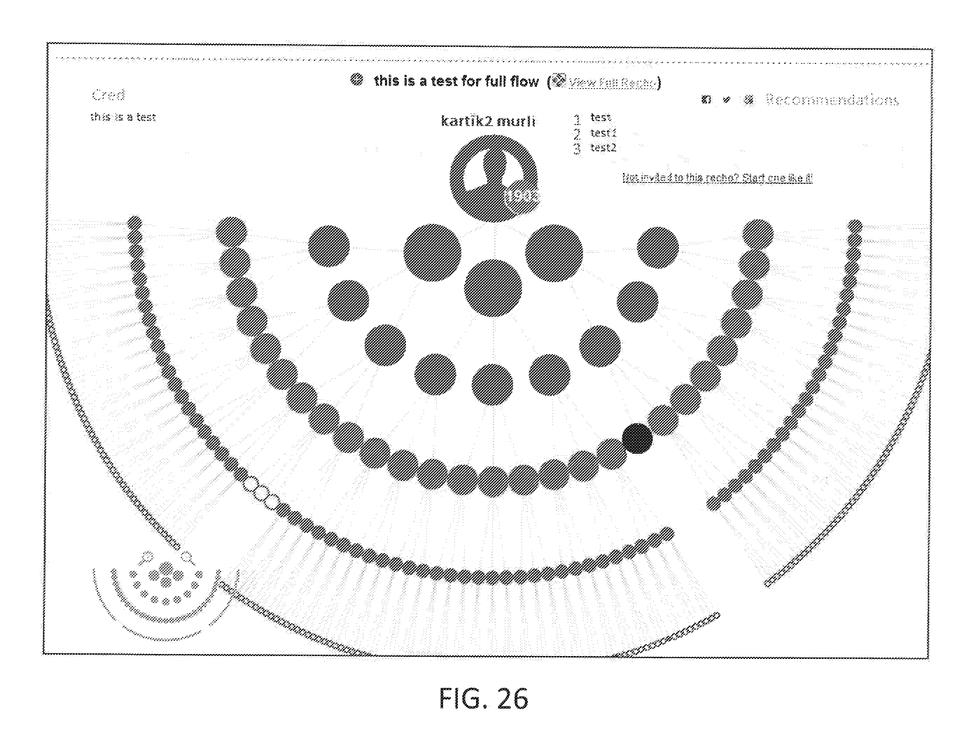

The first step in the process to display a recho can be to initiate a search by subjects or rechoes. Recho structures can also be displayed from the Home Page and Public and Private Profile pages. In the following paragraphs screen shots and documentation of web/application and database server activities is detailed.
User interface: As depicted in FIG. 24, user clicks “Rechoes” radial button when searching a subject. A text box allows for entry of key words for the system to use in search. Possible matches are listed in a drop-down box from which the user can select one.
Server function: The server applies logic to search subject lines of rechoes already created in the system, which data is stored in a memory. The database is queried as the user types and the list will change based on best matches up until the user stops typing.
Database Tables involved: Table Recho is queried for subject statements.
User interface: As depicted in FIG. 25, a user selects one of the drop-down items, the system then follows a process to return the data in each line item. The user can click the subject statement under the word “Recho” to display the structure. The server queries the database.
Server function: The server queries the database and assembles data real-time for view by the user. Data is kept in local machine cache until browser session ended.
Database Tables involved: Table Recho for the subject and recommendation count, Table Rechoer for first, last name, the corresponding image from the container and Table Recommendation for the cred statement.
When a subject is clicked on from the search results page, a structure as depicted in FIG. 26 is rendered. Each “circle” represents a rechoer (responder), with lines between circles leading to different rings representing connections between requesters and responders (invitees and answering rechoers). The following high-level steps occur to build and render the structure on screen:
a. Server calls all information from database required to populate information in text and pop-up boxes
   i. subject and recommendation count from Table Recho,
   ii. recommendations, cred and level of the structure to place data from Table Recommendation,
   iii. rechoer first and last name from Table Rechoer
   iv. images for users from a shared image storage container
b. All data is then converted to JSON or similar format.
c. At recho page load time the recho structure is created based on the data.
d. After creating the recho structure, the system retrieves the objects and can write events for recho to add pop-ups on hover and click or other selection action. Zoom effect is also applied after recho creation.
   One notable point is that in this embodiment the system builds the entire structure each time it is called by a user. Other embodiments are coded to build the structure as the user navigates through it or from a certain point where the user is at currently outward.

### Hover or Mouse-Over or Other Selection in Recho Structure

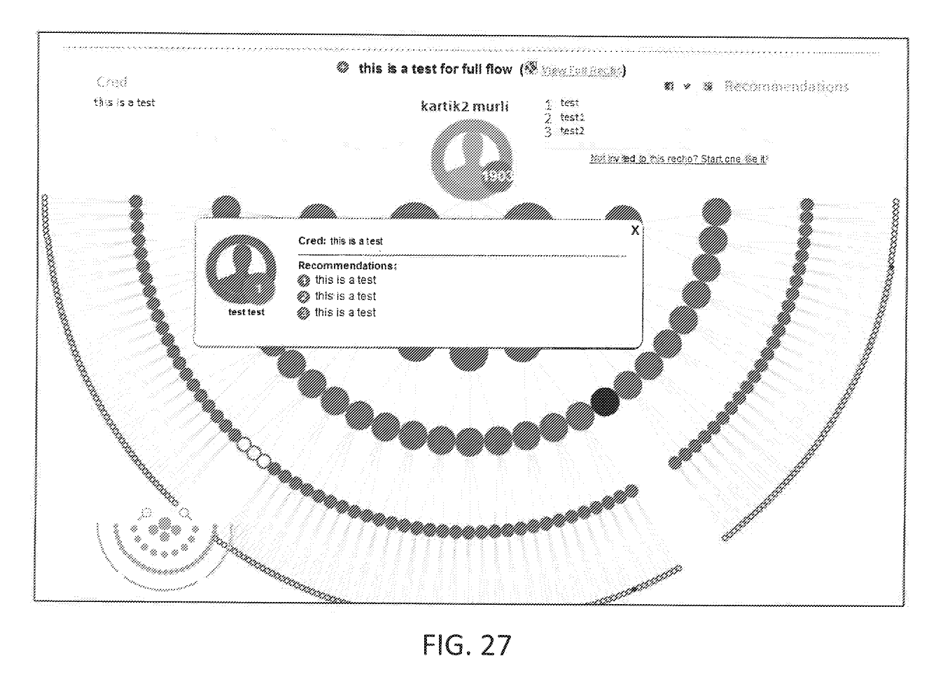

User interface: As depicted in FIG. 27, user can select by mouse over or hover their mouse pointer over or otherwise select any of the circles/nodes in the structure to cause the display to show a summary of that rechoer's cred and reechoes and other information. This results in the system responding by expanding available information graphically. For example, in one embodiment, the system returns a box which will disappear as soon as the mouse is moved, or can be “nailed up” by one click of the mouse and then closed.
Server function: JavaScript tools are providing capability.
Database Tables involved: Because the entire structure is built the data is transacting between the web server and user. The tool to allow hovering our mouse-over is applied to enable capability for the user.

### Depiction of Zoom Feature

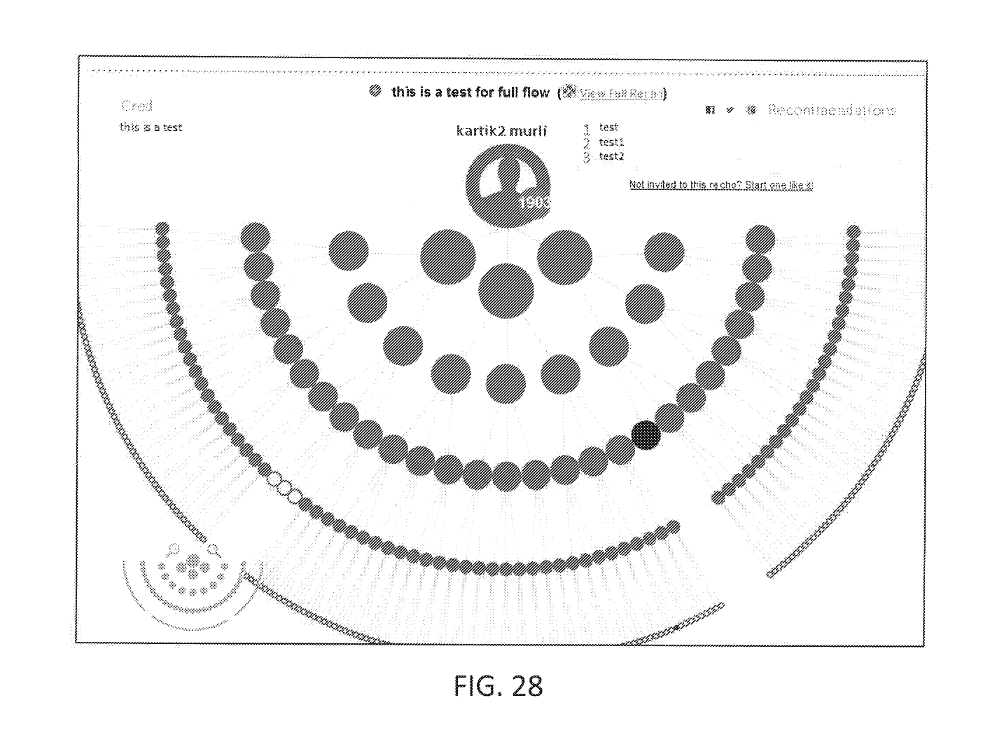

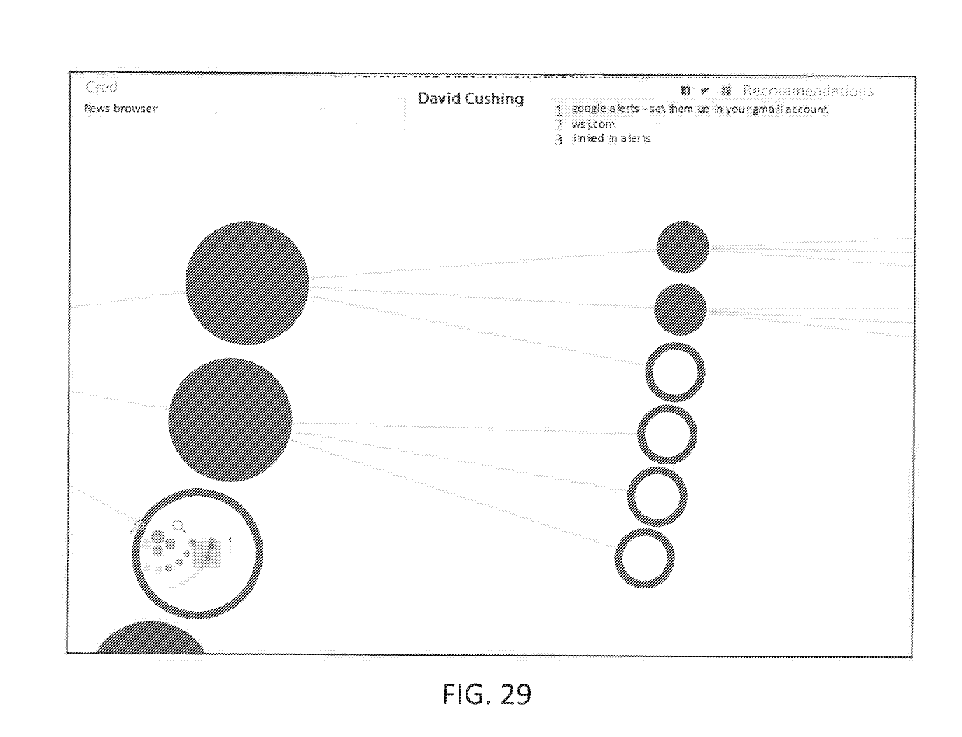

User interface: Using the key graphic in the lower left hand corner of FIG. 28 a user can zoom in on specific areas of the recho structure image. User is able to draw a box on the key as shown in FIG. 28. When the user releases the mouse key, the result is as depicted in FIG. 29. This is but one example of a highlight feature useful to focus on a subset of the GUI and corresponding data. Other examples include other steps of graphical selection of a portion of the information available on the screen.
Server function: Server is employing JavaScript tools to enable functionality facing the user.
Database Tables involved: Because the structure was built completely when called up by the user, no database queries are required.

### Potential Uses for Content in Rechoes

A wide variety of uses of the system should drive equally wide uses of the data. Uses of Rechoes include but are not limited to:
include the conducting of surveys and polls (in which users are presented choices to select from),
gathering predictions,
recommendations on goods, service providers or businesses
informal conversations among friends
business discussions between employees of a company, colleagues across companies
political opinion gathering
focus groups
gaming applications
   One example of use of the content driven by uses of the system is by a consumer products company that based on Rechoes having tabulated mentions of the company's name and products by name will want to market to the community in Rechoes. Another example use is for executives at a company to gather opinions about strategy from their employees, replacing in some applications employee surveys. Another business application may be to engage work teams and organize certain work team communications. Data gathered in the system could be mined to provide marketing information to companies and potentially sell advertising space to them.

In many embodiments, further steps of data mining and other analysis may be performed on responses provided by rechoers. By way of example, rechoes may identify and display data such as the most popular response(s), least popular response(s), most popular response by demographic rechoer (e.g., “women ages 19-24 chose answer A as best, and C as second best”; “rechoers from your zip code most often suggested Tuffy's as their favorite place to get a burger . . . ”), categorization of responses, filtering of responses to remove flagged content, and the like.

Some applications lend themselves particularly well to gaming and related predictive applications. As an example, a rechoe may request favorites to win the super bowl or other sporting event. Analysis may be performed on responses to create a statistical prediction model (e.g., 49% of rechoers predict the Bears will win the Super Bowl, 30% predict the Patriots will, 17% predict the Bengals, and 6% predict others will) or for other reasons. Many other analysis of responses can be provided as will be appreciated by those knowledgeable in the art.

Other advantages and benefits of Rechoes system embodiments will be apparent in other embodiments and will result from unique steps taken by the system. Rechoes is a system in which many people are expected to be invited to join by people they know. Following are some unique attributes:

1. Users are invited by someone they know,

2. while users may know other users in the universe of Rechoes, more importantly the recho is an environment that is closed to entry other than by invitation, with the result that all users in a particular recho are somehow connected to one another,

3. the subject is free-form, not indexed or curated by anyone but completely authored by the creator/requestor,

4. the cred and opinions users are asked to supply are also free-form and therefore completely authored and unlimited, but like the subject are limited to 100 (or other number) of characters which naturally limits how much can be expressed. However, much can be expressed in 100 characters because the character limitation forces people to choose meaningful words and phrases to write down.

5. Finally and most importantly all the answers given are in one structure, a recho that can be browsed for quick reads of the information or in some embodiments searched on multiple levels to compile more detailed information.

Because of the above and other unique features, embodiments of Rechoes will produce information that is valuable to identify trends in any number of areas—science, sports, finance, gaming, professional, education, music, fashion, pop culture, politics, and others—by virtue of its invitation-driven process to create content combined with character-limited fields for authoring individual cred statements and opinions. By virtue of structure alone, this information will be significantly different from the information contained in other social media sites, blogs and recommendation forums not to mention traditional survey techniques. Once collected Rechoes allows the information to be searched, displayed in various combinations and constructs and tabulated in ways that can be assigned different values by audience. In addition and more importantly the content in rechoes may be interpreted through the lenses of time, how the subject is expressed, rechoer demographics and other dimensions to model and predict responses to product offerings, political initiatives, sporting event viewership or team sentiment, celebrity or fashion popularity and trending, and according to other organizational schema.
By way of further illustration, following are some examples:
A survey selects a statistically relevant sample of households to ask the question—“What is the best laundry detergent?” Either discrete choices will be provided, or the construct will be to answer with a product name given how the question was asked. A product management executive at a consumer goods company would read results as raw numbers and calculated statistics while accounting for relevancy of the statistics and demographic profile (assuming some data is gathered) information. Interestingly a good question might be “are the questions being asked really important to the person being surveyed or not?” Presumably if someone takes the time to answer a survey they must be to at least some degree.
In Rechoes a person in Willowbrook, Ill. might have developed one or two great ways to remove normally bad stains like grass, blood or red wine from clothes. The person could create a recho with the statement “My ways to get tough stains out of clothes.” The opinions provided by the person creating the subject might mention products but may not and would certainly describe a process that worked (and maybe others that did not!). That person would then invite three more people to weigh in with their thoughts on the subject.
As this process continues through reechoes more users (growing geometrically) will respond to requests by offering their ideas—some similar to others but all unique in tone, emphasis, subject/verb construct, sharing of the “why,” and all the other dimensions that come with self-expression that is unbounded except by character limitation. Also passions will arise and be expressed—“This was a nightmare” or “Devastated when I spilled wine on my best dress”—and victory and pride will be communicated—“I figured this out on my own” or “Learned through trial and error.”
A consumer products analyst wanting to know how people use his company's detergent can tabulate numbers from the content based on key word search in some embodiments of the invention but utilizing other methods in other embodiments. The greater value however is in the free expression of thought and intelligence of the participants. Product features that had not been thought of before may eliminate a step requiring another product and the time required to apply it before using the company's product to really work. The recho structure allows for efficient analysis of the data even though it is in text format. In this way embodiments will enhance data mining capabilities to the benefit of researchers.
It will be appreciated that illustration of example system, method and program product embodiments has been made, but that these illustrations are not intended to limit the scope of the invention to the features illustrated. Instead, those skilled in the art will appreciate that many variations, substitutions, and alternate features are readily available.

1. A method for communicating information over a data network and for displaying resultant information over the data network, comprising the steps of:
an initiating participant asking a question of a primary responder over the network;
the primary responder providing a first answer to the question over the network and recommending at least one secondary responder to provide an answer to the question;
each of the at least one secondary responder providing a second answer to the question over the network and further recommending at least one tertiary responder to provide an answer to the question;
the at least one tertiary responder providing a third answer to the question over the network; and,
a computer receiving each of the first, second and third answers and creating a graphical display that displays the answers in a hierarchical manner that graphically indicates the relationship between the primary responder, the at least one secondary responder, and the at least one tertiary responder.

2. A method as defined by claim 1 wherein the at least one primary responder comprises two primary responders, wherein the at least one secondary responders comprise two secondary responders, and the at least one tertiary responder comprises two tertiary responders.

3. A method as defined by claim 1 wherein:
each of the primary, secondary and tertiary responders communicate registration data to the computer including at least identity information and a password that is stored by the computer in a non-transitory memory;
each of the primary, secondary and tertiary responders communicate their respective password over the network together with their respective answers; and
the computer further displays at least a portion of the corresponding identity information of corresponding responders with each of their respective answers.

4. A method as defined by claim 1 wherein the hierarchical display includes linking answers in a graphical manner to indicate how far removed from the initiating participant the answer was provided, wherein the tertiary responder answer is displayed a farther distance from the question than is the primary responder answer.

5. A method as defined by claim 1 wherein the computer allows access to the hierarchical display together with the question for viewing by at least a first viewer over the network, the at least a first viewer different from each of the initiating participant, primary responder, secondary responder, and tertiary responder.

6. A method as defined by claim 1 wherein:
each of the primary, secondary and tertiary responders provide credentials over the network that are stored by the computer, the credentials used by the computer to determine qualifications of each of the primary, secondary and tertiary responders to provide an answer to the question; and
the computer displays the credentials with the corresponding answer.

7. A method as defined by claim 1 wherein the computer operates to limit the primary responder to inviting no more than three secondary responders, and limits each of the secondary responders to invite no more than three tertiary responders.

8. A method as defined by claim 1 wherein
each of the at least one tertiary responders invites at least one subsequent responder, and each subsequent responder invites at least one further responder, and wherein this process is repeated over additional cycles wherein any responder can recommend at least one additional responder and wherein a growing network of responders and answers is collected by the computer; and
wherein the graphical display of answers created by the computer includes all of the answers collected and displays all of the answers in the hierarchical manner that graphically indicates the relationship between particular of the answer and the question.

9. A method as defined by claim 1 and further comprising the step of limiting each of the answers to a character length that is no greater than 100 characters.

10. A method as defined by claim 1 wherein
the computer tabulates the number of answers that each responder has provided over time, stores the tabulation in a non-transitory memory, and uses this tabulation to create a responder rating and displays the responder rating with answers from each of the corresponding responders in the graphical display.

11. A computer program product for collecting, organizing and displaying answers to at least one question, the program product comprising executable instructions stored in a non-transitory memory, the instructions when executed causing one or more computers to carry out steps comprising:
receive registration data from a plurality of responders over the network, each of the responders providing credentials, personal information and a password;
store the registration data in a non-transitory memory;
receive a question from a requester over the network and communicating the question to a first set of responders that has been specified by the requestor;
receive answers to the question and a second set of responders from the first set of responders over the network;
communicate the question to the second set of responders;
receive answers to the question and a third set of responders from the second set of responders over the network;
communicate the question to the third set of responders;
receive answers to the question and a fourth set of responders from the third set of responders over the network;
communicate the question to the fourth set of responders;
receive answers to the question from the fourth set of responders over the network;
create a graphical display that represents each of the answers received from the first, second, third and fourth sets of responders in a hierarchical arrangement that indicates relative distance from the requestor wherein the answers received from the fourth set of responders are displayed a greater distance from the question than are the answers received from each of the first, second and third set of responders; and,
receive a request from at least one third party to view the graphical display together over the data network and respond to the request by displaying the graphical display, wherein the at least one third party is not a requestor or a responder.

12. A computer program product as defined by claim 11 wherein the computer further executes the steps of:
repeate the steps of claim 11 for a multiplicity of questions whereby a multiplicity of questions and resulting graphical displays of answers are displayed; and,
provide search capabilities and respond to a search request by identifying a particular graphical display from the multiplicity thereof that corresponds to the search request.

13. A computer program product as defined by claim 12 wherein the computer further executes the step of crosslinking between different graphical displays to indicate one or more of related questions and related responders.

14. A computer program product as defined by claim 11 wherein the computer further executes the step of:
recording the number of answers provided by each of the responders;
recording a responder rating for each responder that corresponds to the number of times that responder has been recommended for answering a question;
reviewing registration data to identify a subset of the portion of responders as experts for at least some subject matter areas;
associating such expert designation, responder rating and number of answers provided data with the registration data for each corresponding user;
including the expert designation, responder rating and number of answers provided data in the graphical display and associated with a corresponding user.

15. A computer program product as defined by claim 11 wherein:
each of the first, second, third and fourth sets of responders are registered responders, and wherein a user may communicate a second question to all registered responders directly at the same time; and
wherein the computer further performs the steps of receiving and storing demographic data from responders and provides search functionality using the demographic data whereby a requestor may limit responders based on demographic data.

16. A computer program product as defined by claim 11 wherein the computer further performs the steps of:
receiving an alert request from a first requester over the network identifying one or more of a subject or an individual responder, and communicating an alert to the first requestor when a question is communicated that is related to the subject or when the individual responder provides an answer;
receiving a credential statement with every answer, the credential statement specifying qualifications that the responder has on the subject of the corresponding question; and,
displaying the credential statement together with the answer from the corresponding responder in the graphical display.

17. A computer program product as defined by claim 11 wherein the graphical display includes a semi-circle with the requester in the center, primary responders defining a first concentric 180° arc, the second responders defining a second concentric 180° arc that is larger than and spaced farther from the center than the first concentric 180° arc, and wherein the requester and responders are represented by graphical icons, icons between 180° arcs connected by lines to represent connections between requester and responders.

18. A computer program product as defined by claim 11 wherein the program instructions further cause the computer to:
respond to a user selection of a portion of the graphical display by magnifying that portion to display additional information not displayed in the un-magnified state; and,
include in the graphical display a plurality of nodes that each represent one answer, and to respond to a user selection of an individual node by displaying the individual answer and corresponding responder identity, such information not displayed when the node is not individually selected.

19. A computer program product as defined by claim 11 wherein the steps are repeated for a second question to create a second graphical display, and wherein the computer further determines which responders that are common to the two questions and represents the common participation by cross-linking between representations of the common responders in the graphical display.

20. A computer program product for collecting, organizing and representing responses to at least one question in a graphical display, the program product comprising executable instructions stored in a non-transitory memory, the instructions when executed causing one or more computers to carry out steps comprising:
receiving registration data from a plurality of responders over the network, each of the responders providing credentials, personal information, a password and demographic information;
receiving a question from a requester over the network and communicating the question to a first set of three primary responders that has been specified by the requestor;
receiving answers to the question and a second set of three secondary responders from each of the first set of responders over the network;
communicating the question to the each of the secondary responders;
receiving answers to the question and a set of three tertiary responders from each of the secondary set of responders over the network;
communicating the question to the each of the tertiary responders;
creating a graphical display of at least three concentric arcs of nodes around a center, each concentric arc including a plurality of nodes, a first of the arcs representing the primary responders with one node representing each primary responder, a second of the arcs representing the secondary responders with one node representing each secondary responder, the third of the arcs representing the tertiary responders with one node representing each tertiary responder, the graphical display further including connections between responders in different of the first, second, third and arcs; and,
responding to selection of a node by a user by displaying the corresponding response, responder identity, and at least a portion of the corresponding credentials and demographic information.
